(19) United States
(12) Patent Application Publication
(10) Pub. No.: US 2026/0235227 A1
(43) Pub. Date: Aug. 13, 2026

(54) USER REPRESSURIZED GAS SPRING-POWERED FASTENER DRIVER

(71) Applicant: MILWAUKEE ELECTRIC TOOL CORPORATION, Brookfield, WI (US)

(72) Inventors: David C. Graf, Greendale, WI (US); Coby A. Nettleton, Milwaukee, WI (US); David A. Bierdeman, New Berlin, WI (US); Marcus M. Wechselberger, Milwaukee, WI (US); Jacob N. Zimmerman, Pewaukee, WI (US); Noah P. Seiler, Milwaukee, WI (US)

(21) Appl. No.: 19/536,924

(22) Filed: Feb. 11, 2026

Related U.S. Application Data
(60) Provisional application No. 63/757,169, filed on Feb. 11, 2025.
(60) Provisional application No. 63/802,263, filed on May 8, 2025.

(51) Int. Cl. F16K 31/50

(52) U.S. Cl. CPC F16K 31/50

(57) ABSTRACT

A powered fastener driver including a cylinder, a piston, a driver blade, and a fill port in fluid communication with the cylinder. The powered fastener driver further includes a housing within which the fill port and the cylinder are positioned, the housing including a fill adapter opening adjacent the fill port, a door selectively engageable with housing at the fill adapter opening between a first position covering the fill adapter opening and a second position uncovering the fill port. The powered fastener driver further includes a mode switching system configured to switch an operating mode of the powered fastener driver, the mode switching system at least partially positioned within the housing and covered by the door when the door is in the first position. The mode switching system is configured to shift the powered fastener driver to a service mode when the door is in the second position.

### CROSS-REFERENCE TO RELATED APPLICATIONS

This application claims priority to U.S. Provisional Patent Application No. 63/802,263, filed May 8, 2025, and U.S. Provisional Patent Application No. 63/757,169, filed Feb. 11, 2025, the entire contents of both of which are incorporated herein by reference.

### FIELD OF THE DISCLOSURE

The present disclosure relates to powered fastener drivers, and more specifically to gas spring-powered fastener drivers.

### BACKGROUND OF THE DISCLOSURE

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.) to drive a driver blade from a top-dead-center position toward a bottom-dead-center position to strike a fastener and drive the fastener into a workpiece.

After prolonged use of gas spring fastener drivers, some gas in a compression chamber thereof may leak therefrom, decreasing the ability of the gas spring fastener driver to properly drive the fastener. In this situation, the compression chamber may need to be refilled. Due to safety risk associated with refilling compressed gas spring fastener drivers, conventional refill operations are conducted a controlled ambient temperature service center by a technician. Some gas spring fastener drivers require a complex and non-intuitive series or sequence of complex actions (e.g., trigger actuations, workpiece contact bracket actuations, mode button actuations, etc.) to transition into a service mode state where the technician can conduct a refill operation. While the tool is at the service center, the end user is undesirably dispossessed of their tool. Conventional gas spring fastener drivers are refilled with a piston thereof at a bottom-dead-center position.

### SUMMARY OF THE DISCLOSURE

The present disclosure provides, in one independent aspect, a powered fastener driver system including: a powered fastener driver including a cylinder in which a compressed gas is maintained; a piston movable within the cylinder from a top-dead-center (TDC) position to a bottom-dead-center (BDC) position by the compressed gas; a driver blade coupled for movement with the piston from the TDC position to the BDC position for driving a fastener into a workpiece; and a fill port in fluid communication with the cylinder through which compressed gas is transferred into the cylinder, the fill port including a first connector; a first fill adapter including a first adapter attachable with the first connector of the fill port to supply compressed gas from an external fluid supply to the cylinder; and a second fill adapter including a second adapter different from the first adapter and incompatible with the first connector of the fill port, thereby preventing the second fill adapter from supplying compressed gas from the external fluid supply to the cylinder.

The present disclosure provides, in another independent aspect, a powered fastener driver system including: a cylinder in which a compressed gas is maintained; a piston movable within the cylinder from a top-dead-center (TDC) position to a bottom-dead-center (BDC) position by the compressed gas; a driver blade coupled for movement with the piston from the TDC position to the BDC position for driving a fastener into a workpiece; a fill port in fluid communication with the cylinder through which compressed gas is transferred into the cylinder; a housing within which the fill port and cylinder are positioned, the housing including a fill adapter opening adjacent the fill port; a door removably coupled to the fill adapter opening to selectively cover the fill adapter opening; and an actuator that is actuatable with the door removed from the fill adapter opening; wherein actuation of the actuator shifts an operating mode of the powered fastener driver between a filling mode, in which the driver blade is held at a fill position between BDC and TDC, and an operating mode, in which the driver blade is capable of moving between BDC and TDC during consecutive fastener driving operations.

The present disclosure provides, in another independent aspect, a method of refilling a powered fastener driver, the powered fastener driver including a cylinder in which a compressed gas is maintained, a piston movable within the cylinder from a top-dead-center (TDC) position to a bottom-dead-center (BDC) position by the compressed gas; a driver blade coupled for movement with the piston from the TDC position to the BDC position for driving a fastener into a workpiece; a fill port in fluid communication with the cylinder through which compressed gas is transferred into the cylinder; an actuator; a sensor, a controller, a lifter assembly capable of lifting the driver blade from bottom-dead-center (BDC) toward top-dead-center (TDC); wherein the method includes the steps of: coupling a fill adapter to the fill port; actuating the actuator to shift the powered fastener driver to a filling mode; sensing, by the sensor, a temperature of the cylinder or an ambient temperature of the powered fastener driver; calculating, by the controller, a fill position for the driver blade based on the sensed temperature or pressure, the fill position being at either BDC, TDC, or between BDC and TDC; actuating the lifter assembly to move the driver blade to the fill position; engaging the lifter assembly to hold the driver blade in the fill position; and supplying compressed gas to the cylinder through the fill adapter and the fill port.

The present disclosure provides, in another independent aspect, a first powered fastener driver operable at a first pressure, the first powered fastener driver including a first cylinder in which a compressed gas is maintained; a first piston movable within the cylinder from a top-dead-center (TDC) position to a bottom-dead-center (BDC) position by the compressed gas; a first driver blade coupled for movement with the piston from the TDC position to the BDC position for driving a first fastener into a workpiece; and a first fill port in fluid communication with the cylinder through which compressed gas is transferred into the cylinder, the first fill port including a first connector; a second powered fastener driver operable at a second pressure higher than the first pressure, the second powered fastener driver including a second cylinder in which a compressed gas is maintained; a second piston movable within the cylinder from a top-dead-center (TDC) position to a bottom-dead-center (BDC) position by the compressed gas; a second driver blade coupled for movement with the piston from the TDC position to the BDC position for driving a second fastener into a workpiece; and a second fill port in fluid communication with the cylinder through which compressed gas is transferred into the cylinder, the second fill port including a second connector; a first fill adapter attachable with the first connector of the first fill port to supply compressed gas from an external fluid supply to the first cylinder; and a second fill adapter attachable with the second connector of the second fill port to supply compressed gas from an external fluid supply to the second cylinder.

The present disclosure provides, in another independent aspect, a powered fastener driver system including: a cylinder in which a compressed gas is maintained; a piston movable within the cylinder from a top-dead-center (TDC) position to a bottom-dead-center (BDC) position by the compressed gas; a driver blade coupled for movement with the piston from the TDC position to the BDC position for driving a fastener into a workpiece; a fill port in fluid communication with the cylinder through which compressed gas is transferred into the cylinder; a housing within which the fill port and cylinder are positioned, the housing including a fill adapter opening adjacent the fill port; a user input mechanism accessible from an exterior of the housing; wherein actuation of the user input mechanism shifts an operating mode of the powered fastener driver between a filling mode, in which the driver blade is held at a fill position between BDC and TDC, and an operating mode, in which the driver blade is capable of moving between BDC and TDC during consecutive fastener driving operations.

The present disclosure provides, in another independent aspect, a powered fastener driver including: a cylinder in which a compressed gas is maintained; a piston movable within the cylinder from a top-dead-center (TDC) position to a bottom-dead-center (BDC) position by the compressed gas; a driver blade coupled for movement with the piston from the TDC position to the BDC position for driving a fastener into a workpiece; a fill port in fluid communication with the cylinder through which compressed gas is transferred into the cylinder; a housing within which the fill port and cylinder are positioned, the housing including a fill adapter opening adjacent the fill port; a door selectively engageable with the housing at the fill adapter opening between a first position covering the fill adapter opening and a second position uncovering the fill port; and a mode switching system configured to switch an operating mode of the powered fastener driver, the mode switching system at least partially positioned within the housing and covered by the door when the door is in the first position, wherein the mode switching system is configured to shift the powered fastener driver to a service mode when the door is in the second position.

The present disclosure provides, in another independent aspect, a powered fastener driver and fill adapter system, the system including: a powered fastener driver including a cylinder in which a compressed gas is maintained, a piston movable within the cylinder from a top-dead-center (TDC) position to a bottom-dead-center (BDC) position by the compressed gas, a driver blade coupled for movement with the piston from the TDC position to the BDC position for driving a fastener into a workpiece, and a fill port in fluid communication with the cylinder through which compressed gas is transferred into the cylinder; and a fill adapter including a manifold, a first coupling engaged with the manifold and configured to be engaged with an external supply of compressed gas, a second coupling engaged with the manifold and configured to be engaged with the fill port of the powered fastener driver, a pressure gauge in fluid communication with the manifold and configured to indicate a pressure of the compressed gas in the cylinder, and a release valve in fluid communication with the manifold, the release valve movable between an open position in which the manifold is in fluid communication with an environment of the fill adapter and a closed position.

Other features and aspects of the disclosure will become apparent by consideration of the following detailed description and accompanying drawings.

### BRIEF DESCRIPTION OF THE DRAWINGS

FIG. 1 is a perspective view of a powered fastener driver in accordance with another embodiment of the present disclosure.

FIG. 2 is a perspective view of the powered fastener driver of FIG. 1, with a portion of a housing hidden.

FIG. 3 is a cross-sectional view of the powered fastener driver, taken along section line 3-3 in FIG. 1.

FIG. 4 is a partial side view of the powered fastener driver of FIG. 1.

FIG. 5 is a side view of the powered fastener driver of FIG. 1, with a portion of a housing hidden.

FIG. 6 is a cross-sectional view of the powered fastener driver of FIG. 1, taken along section line 6-6 in FIG. 5 and with a fitting and a plug engaging a fill port.

FIG. 7 is a cross-sectional view of the fitting of FIG. 6 and an adapter engaging the fitting.

FIG. 8 is a graphical representation of fill pressures of a plurality of fastener drivers as separated into groups compatible for engagement by different adapters.

FIG. 9 is a perspective view of a powered fastener driver in accordance with another embodiment of the present disclosure.

FIG. 10 is a perspective view of the powered fastener driver of FIG. 9, with a portion of a housing hidden.

FIG. 11 is a cross-sectional view of the powered fastener driver of FIG. 9 taken along section line 11-11 in FIG. 9.

FIG. 12 is a partial side view of the powered fastener driver of FIG. 9.

FIG. 13 is a side view of the powered fastener driver of FIG. 9, with a portion of the housing hidden.

FIG. 14 is a cross-sectional view of the powered fastener driver of FIG. 9, taken along section line 14-14 in FIG. 13 and with a fitting and a fill adapter engaging a fill port.

FIG. 15 is an enlarged cross-sectional view of the powered fastener driver of FIG. 9, taken along section 15-15 in FIG. 14.

FIG. 16 is a side view of the fill adapter of FIG. 14.

FIG. 17 is an end view of the fill adapter of FIG. 14.

FIG. 18A is a schematic cross-sectional view of the fill adapter of FIG. 14 in a filling position.

FIG. 18B is a schematic cross-sectional view of the fill adapter of FIG. 14 in a bleeding position.

FIGS. 19A-19C are views of alternate housing openings and adapters with various compatible shapes.

FIG. 20 is a perspective view of an alternate fill adapter assembly and connector with compatible interlocking slots and pins.

FIG. 21 is a perspective view of another alternate fill adapter assembly and connector with compatible a ball retainer and profile.

FIG. 22 is a flow chart illustrating a method of refilling the powered fastener driver.

FIG. 23 is a graph illustrating tool energy over temperature during transport of the tool and after a refill of the tool.

FIG. 24 is a graph illustrating tool energy over temperature at different refill ambient temperatures.

FIG. 25 is a flow chart illustrating an adaptive refill method for the powered fastener driver.

FIG. 26 is a cross-sectional view of a powered fastener driver in a refill mode with its piston in an adaptive fill position between bottom-dead-center and top-dead-center.

FIG. 27 is a cross-sectional view of a powered fastener driver in a refill mode with its piston in an adaptive fill position at bottom-dead-center.

FIG. 28 is an exploded view of a first stage of a transmission and one-way clutch mechanism.

FIG. 29 is an end view of the first stage of the transmission and one-way clutch mechanism.

FIG. 30 is a cross-sectional view of a fill port, connector, and plug.

FIG. 31 is a cross-sectional view of fill adapter engaged with the connector and fill port of FIG. 30.

FIG. 32 is a cross-sectional view of another fill port and plug.

FIG. 33 is a cross-sectional view of a fill adapter engaged with the fill port of FIG. 32.

FIG. 34 is a perspective view of another fill adapter assembly.

FIG. 35 is a chart illustrating exemplary acceptable refill ranges over various ambient temperatures.

FIG. 36 is a is a graph illustrating target fill pressure, regulator high tolerance pressure, and regulator low tolerance pressure over various ambient temperatures.

FIG. 37 is a perspective view of another fill adapter assembly.

FIG. 38 is a cross-sectional view of the fill adapter assembly of FIG. 37 taken along section line 38-38 in FIG. 37.

FIG. 39 is a flow chart illustrating a method of refilling a powered fastener driver with the fill adapter assembly of FIG. 37.

FIG. 40 is a side view of a powered fastener driver including a door enclosing a fill port.

FIG. 41 is a side view of a powered fastener driver with a mode switching button behind the door of FIG. 40.

FIG. 42 is a side view of a powered fastener driver with a mode switching handle door sensor behind the door of FIG. 40.

FIG. 43 is a side view of a powered fastener driver with a mode switching plug sensor with the plug coupled to the powered fastener driver.

FIG. 44 is side view of the powered fastener driver of FIG. 43 with the mode switching plug sensor and with the plug removed from the powered fastener driver.

FIG. 45 is a side view of a powered fastener driver with a mode switching fill adaptor sensor with the fill adapter removed from the powered fastener driver.

FIG. 46 is a perspective view of the powered fastener driver of FIG. 45 with the mode switching fill adaptor sensor sensing a fill adapter coupled to the powered fastener driver.

FIG. 47 is a flow chart illustrating a method of mode shifting a powered fastener driver to a service mode.

FIG. 48 is a side view of a powered fastener driver with a motor housing portion having a removable door.

FIG. 49 is a cross-sectional view of the powered fastener driver of FIG. 48.

FIG. 50 is a side view of a powered fastener driver with a motor housing portion having an access port.

FIG. 51 is a cross-sectional view of the powered fastener driver of FIG. 48.

FIG. 52 is a flow chart illustrating a method of mode shifting a powered fastener driver to a service mode.

FIG. 53 is a perspective view of a fill adapter kit including a case and at least the fill adapter assembly of FIG. 37.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

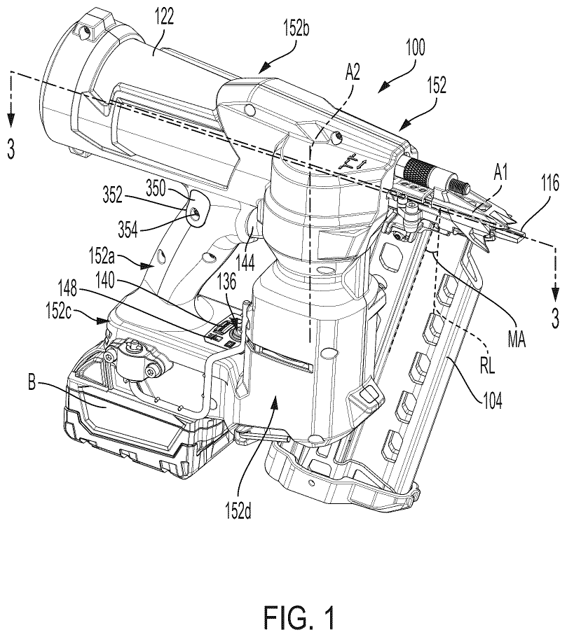

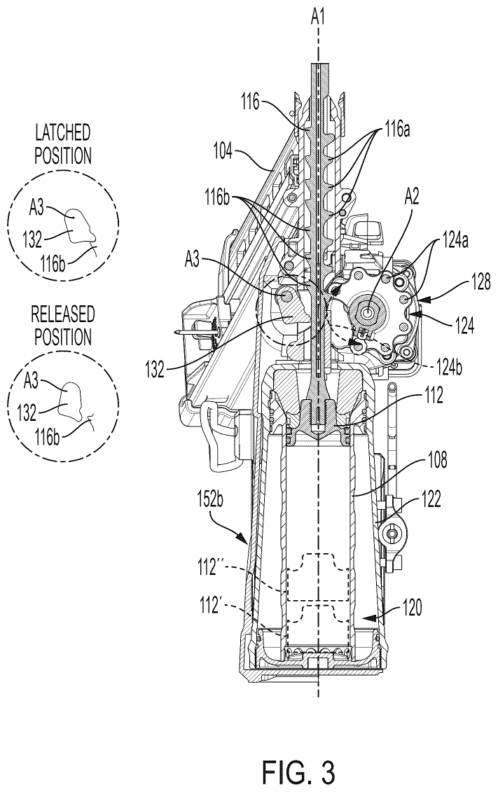

With reference to FIGS. 1-5, a gas spring-powered fastener driver 100 is operable to drive fasteners (e.g., nails, tacks, staples, etc.) held within a magazine 104 into a workpiece. The fastener driver 100 includes a cylinder 108 (i.e., a piston cylinder, inner cylinder 108) and a piston 112 positioned within the cylinder 108 (FIG. 3) and movable within the cylinder 108. With reference to FIG. 3, the fastener driver 100 further includes a driver blade 116 that is attached to the piston 112 and moveable therewith. The fastener driver 100 does not require an external source of air pressure, but rather includes a storage chamber 120 (i.e., a pressure chamber, cylinder) of compressed gas (i.e., pressurized gas) in fluid communication with the cylinder 108. In the illustrated embodiment, the storage chamber 120 and cylinder 108 are encompassed by an outer chamber 122 with the outer chamber 122 and the cylinder 108 together forming the storage chamber 120. In the illustrated embodiment, the cylinder 108 and piston 112 are positioned within the storage chamber 120.

With reference to FIG. 3, the cylinder 108 and the driver blade 116 define a driving axis A1. During a driving cycle, the driver blade 116 and piston 112 are moveable along the driving axis A1 between a fully lifted top-dead-center position (i.e., TDC; see piston 112′) and a fully driven bottom-dead-center position (i.e., BDC; see piston 112).

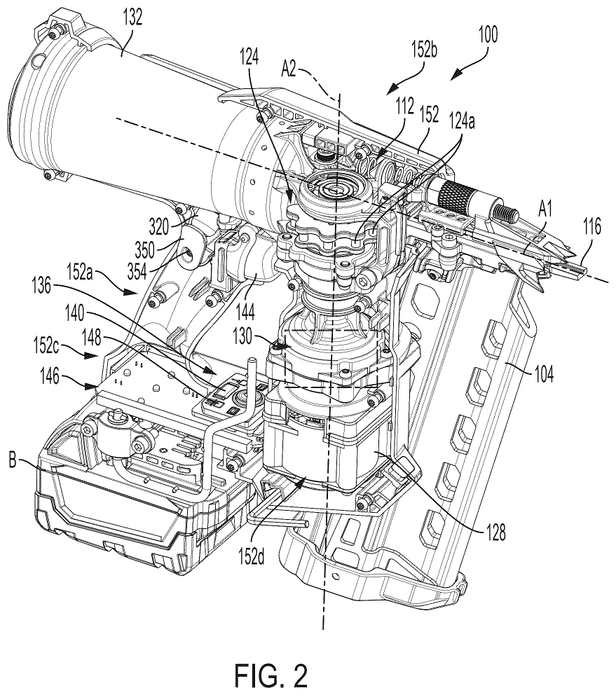

The fastener driver 100 further includes a lifting assembly 124, which is powered by a motor 128 (FIG. 2), and which is operable to move the driver blade 116 from the driven position toward the fully lifted position.

The motor 128 is electrically coupled to a battery pack B coupled to the fastener driver 100, although other power sources (e.g., AC input power) are possible. The lifting assembly 124 includes a plurality of lifter teeth 124a that sequentially engage corresponding driver blade teeth 116a on one side of the driver blade 116. The lifter teeth 124a may be circumferentially arranged about lifter axis A2 with even spacing corresponding with spacing of the driver blade teeth 116a and with a gap 124b between two adjacent lifter teeth 124a larger than the even spacing between the other lifter teeth 124a. The lifting assembly 124 may be rotatable about the lifter axis A2 (e.g., in a counter-clockwise direction as viewed from FIG. 3) to lift the driver blade 116.

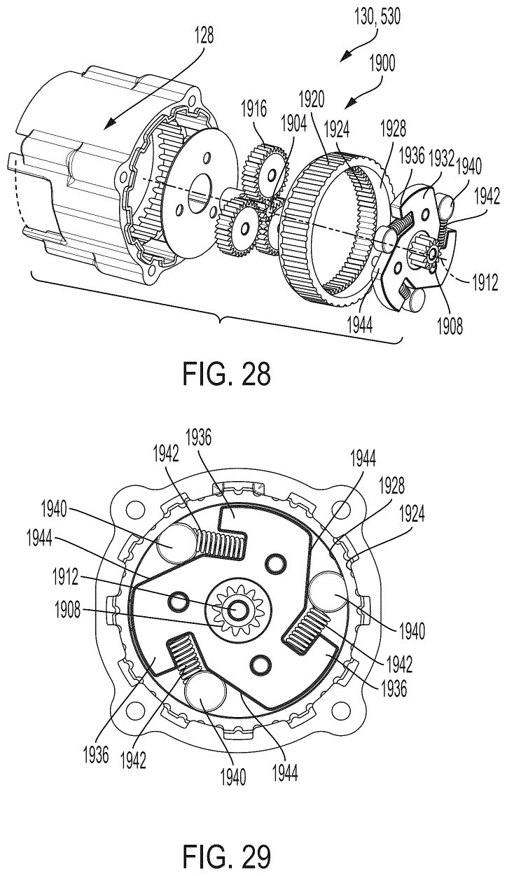

The fastener driver 100 further includes a one-way clutch mechanism 130 between the lifting assembly 124 and the motor 128. The one-way clutch mechanism 130 may part of or incorporated into a single stage or multi-stage transmission, which is optionally a planetary transmission. The one-way clutch mechanism may permit transfer of torque in a first rotational direction from the motor 128 to the lifting assembly 124 yet prevent the motor 128 from being driven in a reverse direction in response to an application of torque from the lifting assembly 124 in an opposite, second rotational direction. The one-way clutch mechanism 130 is capable of holding the driver blade 116 in the ready position (e.g., as illustrated by piston 112″) and the adaptive refill position as explained further below. Structural components of an exemplary one-way clutch mechanism 130 is illustrated in FIGS. 28 and 29. After operating the motor 128 and rotating the lifting assembly 124 to lift the driver blade 116 and piston 112 to a desired position (e.g., standby position, adaptive refill position, etc.), the motor 128 can be deactivated, thus stopping rotation of the lifting assembly 124, and the one-way clutch mechanism 130 may engage to prevent driving of the driver blade 116 by pressure within the storage chamber 120.

The fastener driver 100 further includes a latch 132 for selectively holding the driver blade 116 and inhibiting undesired movement of the driver blade 116 toward the BDC position. The latch 132 may selectively engage latch teeth 116b of the driver blade 116. The latch 132 is movable between a latched position and a released position. The latch 132 may be rotatable about a latch axis A3. Optionally, the latch axis A3 is generally parallel to the lifter axis A2. In the latched position, the latch 132 engages and holds the driver blade 116 against the biasing force of the compressed gas in the storage chamber 120. In the released position, the driver blade 116 is disengaged from the driver blade 116, and the driver blade 116 is permitted to be driven by the force of expanding compressed gas toward the fully driven position. The latch 132 may be one component of a latch assembly including a mechanism capable of shifting the latch 132 between the latched position and the released position. For example, the latch 132 may be one component of a latch assembly including a solenoid that is energized and de-energized to transition the latch 132 between the latched position and the released position.

With reference to FIG. 2, the fastener driver 100 may include a user interface 136 with a user input mechanism 140 (e.g., button, touch screen) capable of receiving input from a user to change an operating mode thereof, and a trigger 144 configured to act as an input to initiate a firing cycle of the fastener driver 100. The user interface 136 is coupled to a controller 146. The controller 146 may include memory with instructions to change operating mode of the fastener driver 100 upon actuation of the user input mechanism 140.

The fastener driver 100 may be operable in a single sequential firing mode, a bump fire mode, a refill mode, and the like. The refill mode is described in detail below. Depending on an operating mode of the fastener driver 100, one or more triggering conditions may initiate a first firing cycle and a subsequent second firing cycle. For example, in single sequential (i.e., semi-automatic) firing mode, a workpiece contact tip may be required to be pushed against a workpiece to permit depression of the trigger 144, with depression of the trigger 144 initiating a first firing cycle. After the first firing cycle, the trigger 144 may be required to be released and subsequently depressed a second time with the workpiece contact tip pushed against the workpiece to initiate the second firing cycle. In an exemplary bump fire mode, the trigger 144 may remain depressed and pushing of the workpiece contact tip against the workpiece initiate the first firing cycle and the second firing cycle without requiring release of the trigger 144. Other firing modes are possible.

The user interface 136 further includes at least one indicator 148 (e.g., light, display, auditory or tactile indicator, etc.) to indicate to the user information regarding the status of the fastener driver 100 and/or the battery pack B. The indicator 148 may indicate, for example, an operating mode (e.g., single sequential firing mode, bump fire mode, refill mode as described below) of the fastener driver 100, a quantity of fasteners present in the magazine 104, an ON/OFF status of the fastener driver 100, any errors related to the fastener driver 100, or the like. In the illustrated embodiment, the user input mechanism 140 and indicator 148 are provided on the same user interface 136. In other embodiments, the user input mechanism 140 and indicator 148 may be physically separated from one another. For example, the user input mechanism 140 may be physically located in the illustrated location on the battery receptacle portion 152c between the handle portion 152a and the motor housing portion 152d and facing upwardly from the battery receptacle portion 152c toward the cylinder portion 152b; and the indicator 148 may be positioned on a rearwardly facing surface of the battery receptacle portion 152c facing away from the motor housing portion 152d; or vice versa. Other arrangements are possible.

Upon initiation of the firing cycle and with the piston 112 beginning at the standby position (e.g., between TDC and BDC), the lifting assembly 124 is activated to move the piston 112 to the TDC position (whereby pressure of the storage chamber 120 is a desired pressure for driving the fastener), and the latch 132 is moved to the released position to not interfere with subsequent downward movement of the driver blade 116. With this arrangement, the compressed gas in the storage chamber 120 is permitted to drive the piston 112 and driver blade 116 toward BDC for driving a fastener into the workpiece.

After driving, the fastener driver 100 may be readied for another firing cycle by operating the lifting assembly 124 to return the piston 112 from BDC to the standby position. One or multiple revolutions of the lifting assembly 124 may be required to lift the driver blade 116 from BDC to the standby position. The illustrated fastener driver 100 includes the same number of driver blade teeth 116a as lifter teeth 124a and requires a single revolution of the lifting assembly 124 to lift the driver blade 116 from BDC to the standby position. While of the driver blade 116 is being driven from TDC to BDC, the gap 124b may face the driver blade 116, and the lifter teeth 124a are thus spaced from the driver blade teeth 116a.

The magazine 104 of the fastener driver 100 is oriented at a magazine angle MA relative to the driving axis A1. The magazine angle MA is measured between the driving axis A1 and a reference line RL extending perpendicularly from the driving axis A1. The magazine angle MA may be between 10 degrees and 80 degrees, or more particularly, between 15 degrees and 45 degrees, inclusive. In the illustrated embodiment, the magazine angle MA of the fastener driver 100 is approximately 21 degrees, and the fastener driver 100 is configured as a framing nailer optimized to drive large nails through dense work surfaces (e.g., for carpentry framing, fencing, decking, roofing, etc.). Other fastener drivers 100 may have differing magazine angles MA and may be optimized for different use cases.

The fastener driver 100 further includes a housing 152 with a handle portion 152a, a cylinder portion 152b within which the cylinder 108 is positioned, a battery receptacle portion 152c configured to receive (or engage) the battery pack B, and a motor housing portion 152d within which the motor 128 is positioned. In the illustrated embodiment, the controller 146 is positioned within the battery receptacle portion 152c, and a bottom of the battery receptacle portion 152c (as viewed in FIGS. 1 and 2) includes a terminal block configured to engage the battery pack B.

In the illustrated embodiment, the user interface 136 is positioned on the battery receptacle portion 152c facing upward (as viewed in FIGS. 1 and 2) toward the cylinder portion 152b. In other embodiments, the user interface 136 may be positioned at other positions relative to the housing 152. For example, the user interface 136 may be positioned on a rearwardly facing surface of the battery receptacle portion 152c facing away from the motor housing portion 152d.

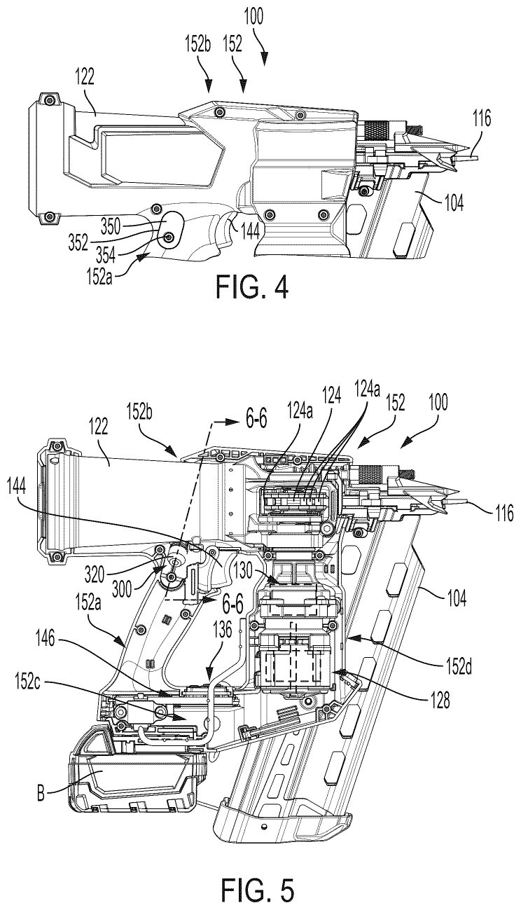

With repeated use of the fastener driver 100 including many firing cycles, some of the pressure of the compressed gas in the storage chamber 120 may escape to atmosphere. With reference to FIGS. 4-7, the fastener driver 100 includes a fill port 300 in fluid communication with the storage chamber 120 (i.e., pressure vessel) through which compressed gas is transferrable into the storage chamber 120.

Compressed gas may be transferred from an external source of compressed gas FS to conduct a first pressurization of the storage chamber 120 during assembly of the gas spring-powered fastener driver 100. The same fill port 300 may transfer gas from the external source of compressed gas FS into the storage chamber 120 to repressurize (i.e., refill) the storage chamber 120 after incidental leakage of the storage chamber 120 during use of the gas spring-powered fastener driver 100.

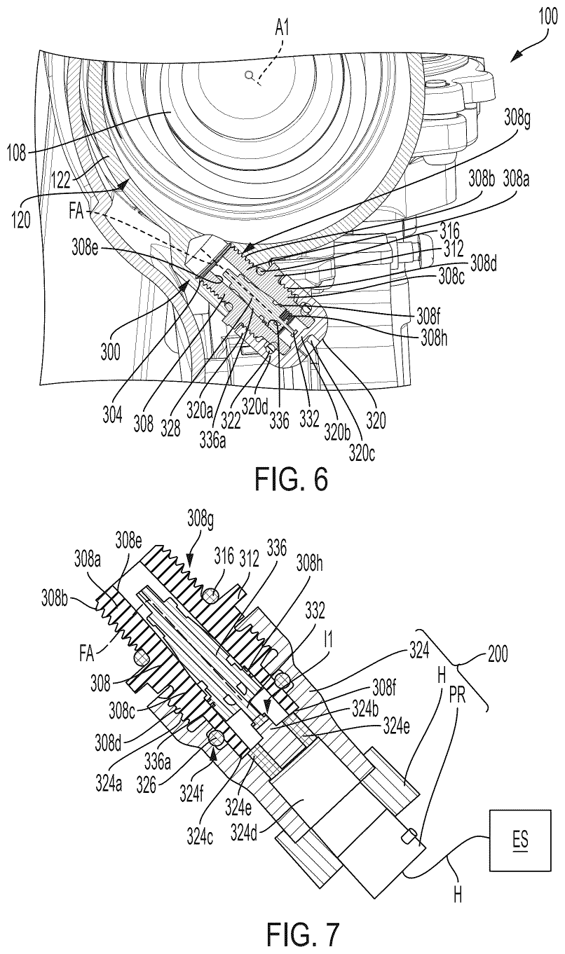

In the embodiment of FIG. 6, the fill port 300 includes threads 304 that are engageable by a connector 308. The illustrated fill port 300 is generally cylindrical in shape and aligned along a filling axis FA. The connector 308 is coupled to the storage chamber 120. The connector 308 includes a tool-side 308a with tool-side threads 308b configured to be secured to the threads 304 and an opposite outer-side 308c with outer-side threads 308d. The tool-side 308a and outer-side 308c are separated by a shoulder 312. An O-ring 316 is positioned adjacent the shoulder 312 to assist in sealing the connector 308 to the storage chamber 120. The tool-side threads 308b are attachable with the threads 304 to secure the connector 308 to the fill port 300. The connector 308 further defines a bore 308e, an outboard axial end surface 308f, and a radial outer surface 308g on which the tool-side threads 308b and the outer-side threads 308d are located. The bore 308e in the illustrated embodiment varies in diameter along a length of the connector 308 along the filling axis FA. The illustrated bore 308e includes a smaller size on the tool-side 308a and a larger size on the outer-side 308c, with a transition in size axially along the filling axis FA near the shoulder 312. The bore 308e may include interior threads 308h.

The outer-side threads 308d of the connector 308 are selectively engageable by a plug 320 and an adapter 324 (i.e., a first adapter 324). In the embodiment of FIG. 6, the plug 320 is secured to the connector 308. The plug 320 is generally dome-shaped. The plug 320 includes internal threads 320a attachable to the outer-side threads 308d. The internal threads 320a of the plug 320 are positioned on an inner surface of the plug 320 that face radially inwardly toward the filling axis FA. The plug 320 further includes an end wall 320b that inhibits access to the interior of the connector 308 when the plug 320 is attached to the connector 308. The end wall 320b includes a non-circular recess 320c engageable by a tool (not shown) to selectively attach the plug 320 to the connector 308. In the illustrated embodiment, the recess 320c is a hexagonal receptacle in which a hexagonal tool (e.g., an Allen key) is received. The plug 320 further includes an O-ring receptacle 320d (i.e., seal receptacle) that receives a plug O-ring 322 to further assist sealing the plug 320 with the connector 308. When fully attached to the connector 308, the end wall 320b of the plug 320 abuts the axial end surface 308f of the connector 308.

In other embodiments, the features of the connector 308 may be integrally formed with the storage chamber 120. In such embodiments, the threads 308d capable of engaging the plug 320 or the adapter 324 may be integral with the storage chamber 120.

With reference to FIG. 7, the fill port 300 is further sealed by a valve 328 (e.g., a Schrader valve) including a valve stem 332 and a valve core 336. The valve 328 may be positioned within the fill port 300 (and in some cases, more specifically, within the connector 308). The valve core 336 may include threads 336a that engage interior threads 308h of the bore 308e. The valve core 336 may be held stationary relative to the bore 308e by engagement of the threads 336a, and interior threads 308h or any other engagement (e.g., press fit, adhesive, etc.). The valve stem 332 may be movable relative to the valve core 336 between an open position whereby fluid is permitted to pass through the valve 328 and the fill port 300, and a closed position whereby fluid is inhibited from passing through the valve 328 and the fill port 300. The valve 328 may be movable between its open position and its closed position upon engagement and disengagement of the adapter 324 with the outer-side threads 308d (i.e., the first connector).

The illustrated valve 328 is a Schrader valve. However, other types of valves 328 are possible. The valve 328 may be any valve capable of being opened and closed when intended to, and as moved between its opened and closed positions due to direct or indirect user input. For example, in other embodiments, the valve 328 may be a one-piece valve that is held in a closed position by pressure applied by gas within the storage chamber 120 and movable to an open position by insertion of a tip into the one-piece valve. In other embodiments, the valve 328 may be a Presta valve including a valve body with a tip that protrudes beyond an open end of the valve body and fill port. The tip of the valve body may include a top nut capable of securing the valve body in a locked state to prevent inadvertent opening of the valve. The illustrated Schrader valve stem 332 may be biased by a spring within the valve 328 toward the closed position. The open position of the valve stem 332 may correspond with a depressed position into the valve core 336 whereby a passageway between the valve stem 332 and the valve core 336 is present.

With continued reference to FIG. 7, the adapter 324 (i.e., a first adapter) is generally annular in shape and includes internal threads 324a attachable to the outer-side threads 308d of the connector 308. The adapter 324 further includes an adapter tip 324b and a radially inwardly extending shoulder 324c. With the adapter 324 fully attached to the connector 308, the shoulder 324c may abut against the outboard axial end surface 308f of the connector 308, and the adapter tip 324b may depress the valve stem 332 by an amount corresponding with interference I1. The interference I1 represents movement of the valve stem 332 between its closed position and its open position. The adapter 324 further includes a primary fill passageway 324d and at least one secondary fill passageway 324e. In the illustrated embodiment, two secondary fill passageways 324e are present on opposite sides of the filling axis FA. The secondary fill passageways 324e simply interconnect the primary fill passageway 324d with the bore 308e when the adapter 324 is attached to the connector 308. Once the adapter 324 is connected to the connector 308, fluid (e.g., gas) from an external source of compressed gas FS may be passed from the primary fill passageway 324d, into the secondary fill passageway 324e, and through the valve 328 into the storage chamber 120. The adapter 324 further includes a O-ring receptacle 324f (i.e., seal receptacle) capable of receiving a fill adapter O-ring 326 (i.e., fill adapter seal). In the illustrated embodiment, the fill adapter O-ring 326 surrounds the filling axis FA and is generally circular in cross-section. In other embodiments, the fill adapter O-ring 326 may be positioned in other locations relative to the filling axis FA, and may include one or more flat surfaces (i.e., the fill adapter O-ring 326 may be non-circular in cross-sectional shape). In the illustrated embodiment, the O-ring receptacle 324f (i.e., seal receptacle) is positioned on a radial inner surface of the adapter 324.

When the adapter 324 is attached to the connector 308, the fill adapter O-ring 326 functions as a seal between the adapter 324 and the connector 308. Because the fill adapter O-ring 326 is positioned between the radial outer surface 308g and the O-ring receptacle 324f at a radial inner surface of the adapter 324, the fill adapter O-ring 326 may be described as a radially outboard seal. In other embodiments, sealing components between the adapter 324 and connector 308 may be located in different outboard positions. The fill adapter O-ring 326 may be repositioned and/or duplicated, for example, to an axially outboard location between the outboard axial end surface 308f and the shoulder 324c. In contrast, a location of the fill adapter O-ring 326 between the radial outer surface 308g or any other sealing element within the bore 308e may be described as an inboard seal internal to the connector 308.

Relative dimensions of the adapter 324 and connector 308 cause, during connection of the adapter 324 to the connector 308, a seal to be formed between the adapter 324 and connector 308 before the adapter 324 actuates the valve stem 332. More specifically, axial lengths and positions of the threads 324a, the outer-side threads 308d, fill adapter O-ring 326 (i.e., fill adapter seal), and the adapter tip 324b are dimensioned such that the fill adapter O-ring 326 seals against the connector 308 before the adapter tip 324b actuates (e.g., compresses) the valve stem 332.

Fluid passing from the external source of compressed gas FS may pass through one or more hoses H (e.g., flexible hoses) to a pressure regulator PR and ultimately to the adapter 324 and the storage chamber 120. The pressure regulator PR regulate the pressure supplied by the external source of compressed gas FS to a desired fill pressure. As schematically illustrated in FIG. 24, the pressure regulator PR may be positioned at an intermediate location in a supply line receiving external fluid from the external source of compressed gas FS by a hose H and passing regulated pressure to another hose H and the adapter 324. In other embodiments, the pressure regulator PR may be positioned adjacent the external source of compressed gas FS (e.g., without a hose H between the external source of compressed gas FS and the pressure regulator PR), immediately adjacent the adapter 324 (e.g., without a hose H between the pressure regulator PR and the adapter 324), and/or at any location in the supply line between the external source of compressed gas FS and the storage chamber 120.

The adapter 324, hose H, and pressure regulator PR may be considered a first fill adapter 200, which is connectable to the connector 308. The first fill adapters 200 is connectable to the connector 308 (i.e., a first connector) and thus the fill port 300 to supply regulated compressed gas from the external source of compressed gas FS to the storage chamber 120. Different fill adapters 324 (i.e., second adapters) with different or similar hoses H and pressure regulators PR maybe considered second fill adapters (not shown).

The plug 320 may be attached to the connector 308 during normal operation of the gas spring-powered fastener driver 100, and the adapter 324 may be attached to the connector 308 during a filling or refilling operation. To further inhibit accidental access of the plug 320 during normal operation of the gas spring-powered fastener driver 100, a door 350 may be secured to an opening 352 in the housing 152 by a fastener 354 to selectively cover the opening 352 (i.e., the fill adapter opening). The door 350 and opening 352 have corresponding shapes so that the entirety of the opening 352 is either opened or closed depending on the presence of the door 350. In the illustrated embodiment, the door 350 and opening 352 are each generally oval shaped from the perspective of FIG. 4. Other shapes for the door 350 and openings 352 are possible. The fastener 354 may be required to be loosened or removed from the housing 152 prior to removal of the door 350 for a user to access the recess 320c by insertion of a tool (e.g., the Allen key) into the housing 152. In the illustrated embodiment, the door 350 is located on a handle portion 152a of the housing 152. The door 350 may be coupled to the opening 352 of the housing 152 to enclose the fill port 300 during normal use (e.g., while not refilling the) of the fastener driver 100.

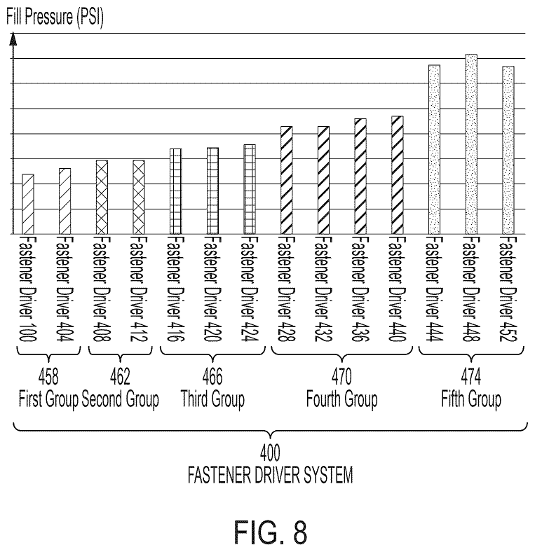

With reference to FIG. 8, a powered fastener driver system 400 may include a plurality of fastener drivers 100, 404, 408, 412, 416, 420, 424, 428, 432, 436, 440, 444, 448, 452. Fastener drivers 100, 404, 408, 412, 416, 420, 424, 428, 432, 436, 440, 444, 448, 452 may be grouped into a first group 458, second group 462, third group 466, fourth group 470, and fifth group 474 depending on target fill pressure requirements of the individual fastener driver, with like fastener drivers being grouped together. Each of the fastener drivers 404, 408, 412, 416, 420, 424, 428, 432, 436, 440, 444, 448, 452 may include features and operate like the fastener drivers 100, 500.

The adapter 324 (i.e., first adapter of first fill adapter 200) may be attachable with a connector (e.g., the connector 308, the “first connector”) onboard the fastener driver 100 and/or the same connector (e.g., outer-side threads 308d) onboard the fastener driver 404. The same adapter 324 (i.e., first adapter of first fill adapter 200) may be attachable to both the fastener driver 100 and the fastener driver 404 to supply compressed gas from the external fluid supply to either the storage chamber 120 or a similar storage chamber onboard the fastener driver 404. Fastener drivers classified in the same group (e.g., the first group 458) may include similar connectors (e.g., the first connector, connector 308) for engaging the same adapter 324 (i.e., first adapter of first fill adapter). Different fill adapters (e.g., second fill adapters) with different adapters, in other words, second adapters 324 that are similar to but different from adapter 324, for example including differing internal threads 324a, can be dimensioned as incompatible with the first connector of the fill port 300. For example, the second adapter 324 internal threads 324a may be incompatible with the outer-side threads 308d thereby preventing the second adapter 324 from supplying compressed gas from the external fluid supply to the storage chamber 120 onboard the fastener driver 100 or the fastener driver 404.

In short, the system 400 permits fastener drivers 100, 404 of the same group 458 to be attachable to (i.e., compatible with) adapters 324 with pressure regulators PR appropriate for filling the fastener drivers 100, 404, while inhibiting attachment of (i.e., being incompatible with) adapters 324 with other pressure regulators PR that are not appropriate for filling the fastener drivers 100, 404. Compatibility and incompatibility of connectivity between adapters 324 and fastener drivers 100, 404 of the system 400 provides error prevention or a mistake proof (i.e., “Poka-yoke”) design that ensures that an end user, for example, is incapable of dangerously overfilling the fastener driver 100, 404 to a pressure higher than the target fill pressure for the fastener driver 100, 404.

Further, different fastener drivers (e.g., fastener drivers 408, 412) in different groups (e.g., the second group 462) may include connectors 308 (e.g., second connectors), for example with outer-side threads 308d that differ from the outer side threads 308d of the fastener drivers 100, 404, such that the second adapters (i.e., second adapters, adapters 324 with differing internal threads 324a) are attachable to the selected fastener driver (408, 412).

In the illustrated embodiment, the first connector 308 may have a first thread pattern (outer-side threads 308d of fastener driver 100), and the first adapter 324 may have a second thread pattern (internal threads 324a of first adapter 324) dimensioned to engage the first thread pattern, whereas the second adapter (internal threads 324a of second adapter 324) may be dimensioned as incapable of engagement with the first thread pattern. The thread patterns may differ in any one or more of minor diameter, major diameter, depth, pitch, pitch diameter, helix angle, thread width, thread angle, length of root, and the like. In other embodiments, other types of mechanical structure differing from dimensions of threads may be used to selectively permit and/or render incompatible and inhibit connection between the fill port 300 (e.g., of fastener driver 100 and the first group 458) with the fill port 300 of other groups (the second through fifth groups 462, 466, 470, 474). For example, inner and outer diameters of the fill port 300, connectors 308, and fill adapters 324 may be dimensioned to selectively permit and/or render incompatible and inhibit connection between the fill port 300 and the fill adapter 324 in comparison with the fill port 300 of other groups (the second through fifth groups 462, 466, 470, 474). In other embodiments, type and/or size of a quick connect coupling may selectively permit and/or render incompatible and inhibit connection between the fill port 300 and the fill adapter 324 in comparison with the fill port 300 of other groups (the second through fifth groups 462, 466, 470, 474).

Dimensions or other compatibility features between the fill port 300 and fill adapters 324 may be selected to permit desired types of fill adapters 324 from connecting with desired types of fill ports 300. For example, if desired, an adapter 324 typically for use with the outer-side threads 308d onboard a fastener driver 408, 412 of the second group 462 may also be attachable (i.e., compatible) with the outer-side threads 308d of the fastener drivers 100, 404 of the first group 458 but not of fastener drivers 416, 420, 424 of the third group 466. Various permutations are possible. Various numbers (e.g., one, two, three, four, more than four) of fastener drivers may be present in any given group 458, 462, 466, 470, 474). The illustrated system 400 includes five groups, however, the system 400 may include any number of groups (two, three, four, five, more than five).

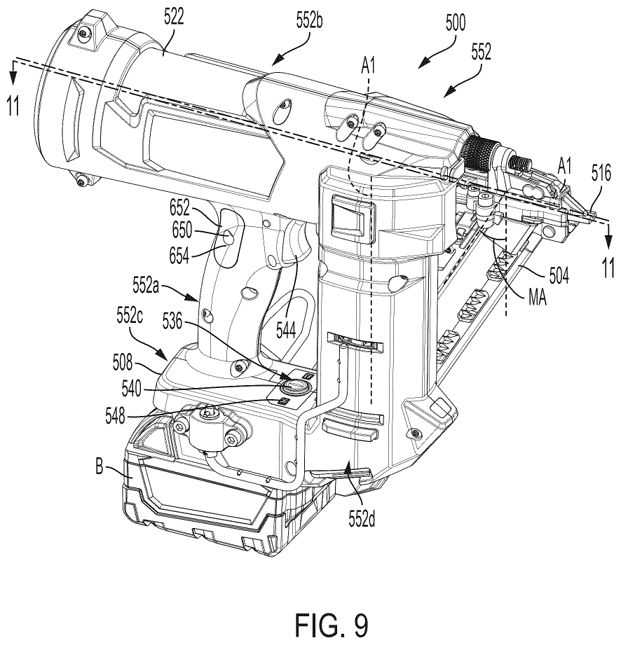

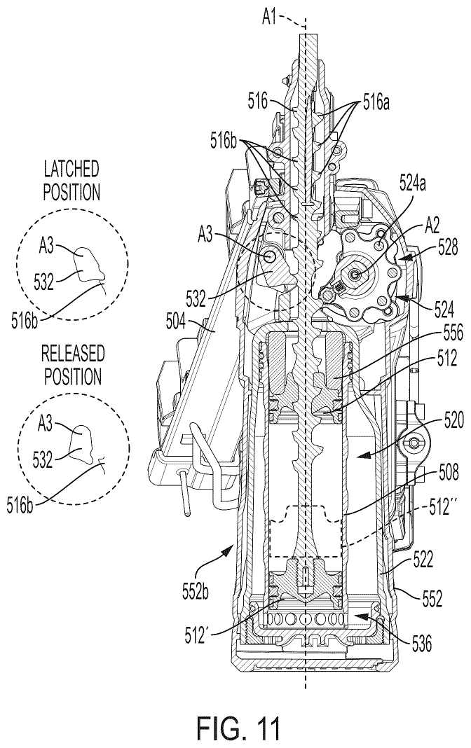

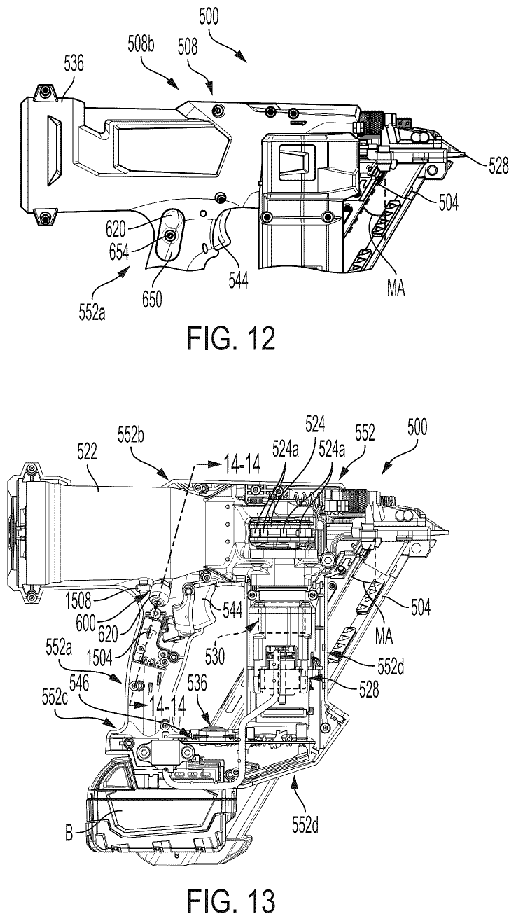

FIGS. 9-15 illustrate another gas spring-powered fastener driver 500. The gas spring-powered fastener driver 500 and fill port 600 includes features like the gas spring-powered fastener driver 100 and the fill port 300 in the ‘500’ and ‘600’ series of reference numerals, respectively. The gas spring-powered fastener driver 500 operates in a similar manner to the gas spring-powered fastener driver 100 as described above. The fastener driver 500 may be, for example, part of the same powered fastener driver system 400 as the fastener driver 100. The fastener driver 500 may be in the same group (e.g., the first group 458) as the fastener driver 100, or a different group (e.g., the second group 462) as the fastener driver 100.

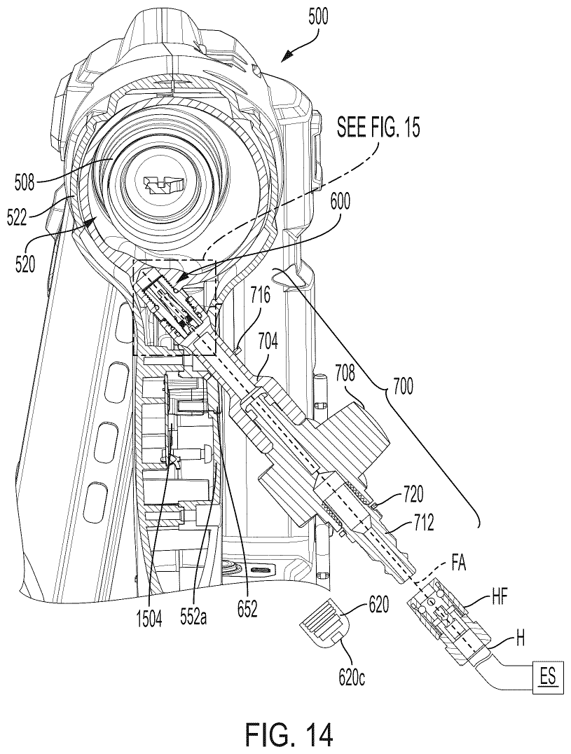

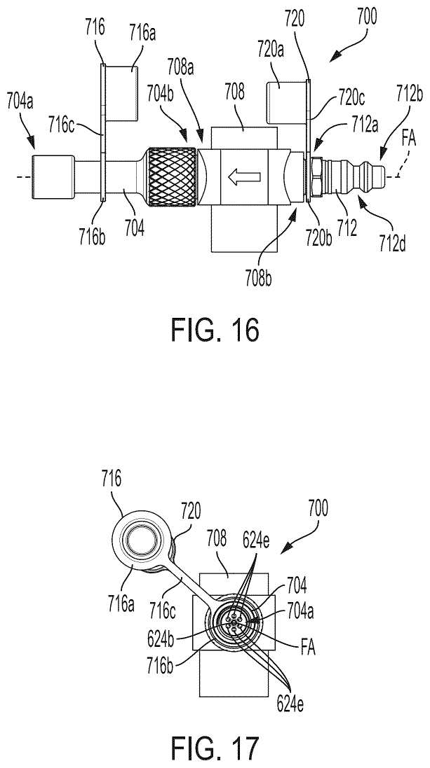

FIGS. 14-18B illustrate a fill adapter assembly 700 (like the fill adapter 200) for engaging and filling the fastener driver 500. With reference to FIG. 16, the fill adapter assembly 700 includes an adapter 704, a pressure regulator 708, and a quick-release fitting 712. The adapter 704 is structurally and functionally similar to the adapter 324 described above. The adapter 704 includes a first end 704a engageable with the connector 608 of the fastener driver 500 and a second end 704b opposite the first end 704a that is engaged with a first side 708a of the pressure regulator 708. The pressure regulator 708 has an opposite second side 708b coupled with a first side 712a of the quick-release fitting 712. The quick-release fitting 712 has an opposite second side 712b engageable with a quick connect hose fitting HF, and thus the external source of compressed gas FS, for example, via hose H. The fill adapter assembly 700 further includes an adapter dust cap 716 and a quick connect dust cap 720.

The first end 704a of the adapter 704 includes internal threads 624a, a fill adapter O-ring 626 (i.e., fill adapter seal), adapter tip 624b, and defines a primary fill passageway 624d and plurality of secondary fill passageways 624e like the adapter 324. As described above with regard to the internal threads 324a, different adapters 704 may include internal threads 624a that differ in dimensions so to provide or inhibit compatibility of the adapter 704 for use in the system 400. For example, the system 400 may include adapters 704 with multiple (e.g., at least two, three, four, or more) types of internal threads 624a.

Further, the system 400 may permit or inhibit connection of the adapter 704 to differing groups 458, 462, 466, 470, 474 based on a size of the fill adapter O-ring 626. For example, an inner diameter of the fill adapter O-ring 626 may be dimensioned sufficiently smaller than an outer diameter of the recess 608c of the connector 608 to inhibit connection between the adapter 704 and the connector 308 such that the adapter tip 624b cannot contact or apply pressure to the valve stem 632 to open the valve 628. Size of the fill adapter O-ring 626 other than an inner diameter thereof may also permit or inhibit connection of the adapter 704 to connectors 608 of other groups 462-474. In the illustrated embodiment, the fill adapter O-ring 626 is positioned outboard of the internal threads 624a along the filling axis FA and with respect to the connector 608. However, in other embodiments, the fill adapter O-ring 626 may be positioned inboard of the internal threads 624a along the filling axis FA and with respect to the connector 608. Other arrangements of threads, O-rings or other sealing members, are also possible. For example, fill adapter O-rings 626 may be positioned on both inboard and outboard sides axial sides along the filling axis of the internal threads 624a, or vice versa.

FIG. 17 illustrates six secondary fill passageways 624e evenly circumferentially spaced about the filling axis FA. Other quantities or arrangements of secondary fill passageways 624e are possible. The first end 704a is generally circular in cross-sectional shape perpendicular to the filling axis FA.

At the second end 704b of the adapter 704, the primary fill passageway 624d has a stepped inner diameter. The primary fill passageway 624d includes a circumferential recess 724. During assembly of the fill adapter assembly 700, the adapter 704 and pressure regulator 708 may be pressed together in an axial direction along the filling axis FA, and a snap ring 728 of the pressure regulator 708 is engageable with the circumferential recess 724 to secure the adapter 704 and pressure regulator 708 to one another. The pressure regulator 708 further includes a pressure regulator O-ring 732 engageable with the interior surface of the primary fill passageway 624d to inhibit leakage from the adapter 704 and pressure regulator 708 to the surroundings.

The second side 708b of the pressure regulator 708 includes internal threads 708c engageable with external threads 712c at the first side 712a of the quick-release fitting 712. Adjacent the opposite second side 712b, the quick-release fitting 712 includes an exterior surface with a recess 712d engageable with the quick connect hose fitting HF. The quick-release fitting 712 may be a quarter-inch (or other size) industrial quick connect fitting. The recess 712d may be engageable with one or more spring biased retaining balls of the quick connect hose fitting HF, the retaining balls being movable in a radial direction perpendicular to the filling axis FA upon engagement or disengagement between the quick-release fitting 712 and the quick connect hose fitting HF.

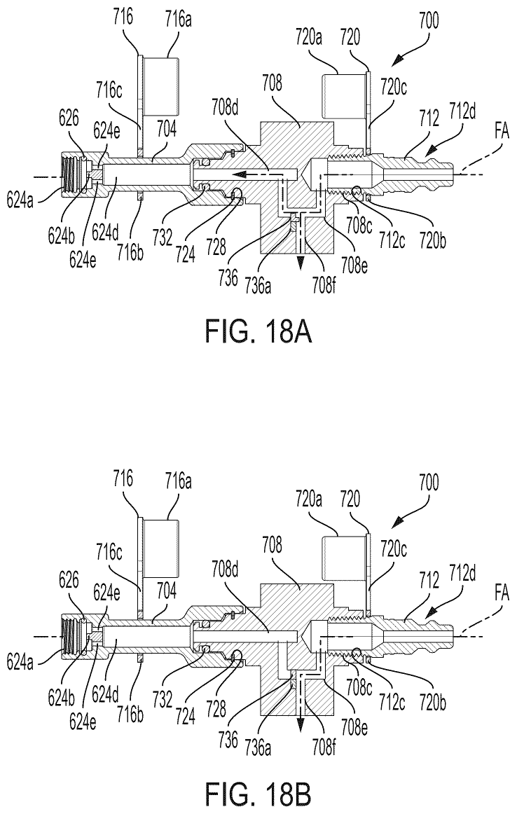

FIGS. 18A and 18B schematically illustrate the internal components of the pressure regulator 708 in a filling arrangement and bleed arrangement, respectively. The pressure regulator 708 includes a first chamber 708d in fluid communication with the primary fill passageway 624d, an opposite second chamber 708e in fluid communication with the quick-release fitting 712, and a bleed chamber 708f in selectively communication with at least one of the first chamber 708d and opposite second chamber 708e. A regulator component 736 of the pressure regulator 708 is schematically illustrated and may be formed by more than one component. The regulator component 736 is movable to a filling position (FIG. 18A) whereby the regulator component 736 permits the first chamber 708d, the opposite second chamber 708e, and the bleed chamber 708f to be in fluid communication with one another. In the filling position, high pressure fluid from the external source of compressed gas FS (e.g., 200 psi) passes through the first chamber 708d and is regulated to a stepped down pressure (e.g.,135 psi) greater than a target pressure for the storage chamber 520 (e.g., 100 psi). As the pressure of the storage chamber 520 reaches the target pressure (100 psi), the regulator component 736 is moved to a bleed position (FIG. 18B) whereby the opposite second chamber 708e and the bleed chamber 708f are in fluid communication with one another, the first chamber 708d is blocked by the regulator component 736, and fluid from the external source of compressed gas FS exits the pressure regulator 708. Movement of the regulator component 736 is initiated due to pressure in the first chamber 708d (as indicative of storage chamber 120, 520 of the connected fastener driver 100, 500) being at the target pressure (100 psi).

In some embodiments, the pressure regulator 708 may be operable only at a single preset target pressure. In other embodiments, the regulator component 736 of the pressure regulator 708 may be adjustable to different settings (i.e., a first setting, second setting, etc.) corresponding with different (i.e., first, second, etc.) preset target pressures in response to connection to geometry of the attached connector 608. In some embodiments of the system 400, the pressure regulator 708 of a single fill adapter assembly 700 may be adjustable to first and second preset target pressures. The pressure regulator 708 may be operable to supply a first preset target pressure when attached to connectors 608 or fill ports 600 of a first size, and the pressure regulator 708 may be operable to supply a second preset target pressure when attached to connectors 608 or fill ports 600 of a second size. For example, the regulator component 736 may be biased by a spring 736a, and an amount of pre-load applied to the spring 736a may be adjusted to facilitate different settings corresponding with different preset target pressures when the pressure regulator 708 is connected to different connectors 608 or fill ports 600 of different sizes to adjust fill pressure (e.g., the stepped down pressure mentioned above 135 psi may be shifted to a different stepped down pressure 110 psi). Adjusting the preload of the spring 736 a effectively adjusts the position of the regulator component 736 in the filling position (FIG. 18A) whereby a ratio of bleed flow through bleed chamber 708f in comparison to filling flow through first chamber 708d is adjusted. Size of the connector 608 or fill port 600 may be an axial length parallel to the filling axis FA, however, other dimensions of the connector 608 or fill port 600 may provide differing structures to bias the spring differing amounts to provide differing fill pressures. Upon connecting the fill adapter assembly 700 to the connector 608 or fill port 600 of a first size, the regulator component 736 is adjusted to a position to supply the first preset target pressure (e.g., 135 psi). Alternately, upon connecting the fill adapter assembly 700 to the connector 608 or fill port 600 of the second size, the regulator component 736 is adjusted to a position to supply the second preset target pressure. The system 400 may adjust the fill pressure to more than two preset target pressure by providing more than two different sizes of the connector 608 or fill port 600.

The adapter dust cap 716 includes a cup-shaped cap portion 716a configured to engage the first end 704a of the adapter 704 when the fill adapter assembly 700 is removed from the fastener driver 500 and not in use and an annular retainer portion 716b configured to inhibit the adapter dust cap 716 from being removed from the adapter 704. A tether portion 716c connects the cup-shaped cap portion 716a and the annular retainer portion 716b. The quick connect dust cap 720 also includes a cup-shaped cap portion 720a, annular retainer portion 720b, and tether portion 720c.

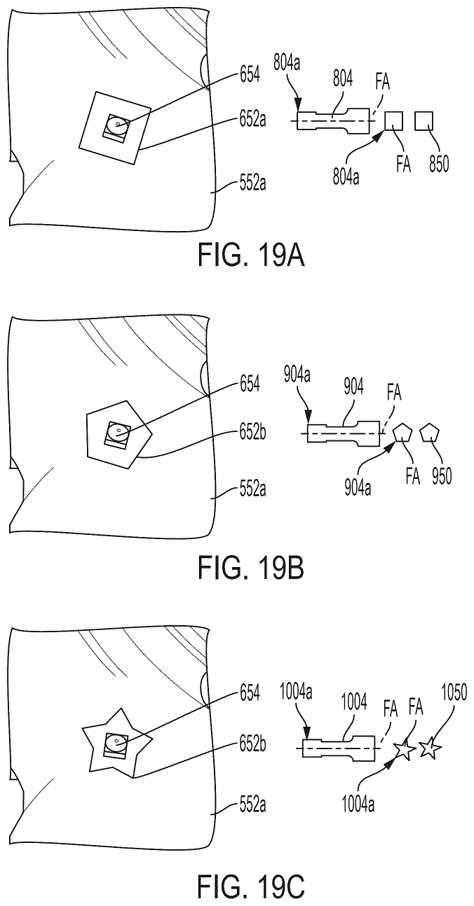

Another arrangement to inhibit connection of adapters 704 to incompatible groups 458-474 of fastener drivers 100, 408-452 is accomplished by shaping the first end 704a of the adapters 704 to be compatible or incompatible with the opening 352. FIGS. 19A-19C illustrate alternately shaped openings 652a, 652b, 652c for receiving correspondingly shaped first ends 804a, 904a, 1004a of alternate adapters 804, 904, 1004 and inhibiting incompatibly shaped adapters. The openings 652a, 652b, 652c are engageable by correspondingly shaped doors 850, 950, 1050. In the illustrated embodiment, the openings 652a, 652b, 652c and first ends 804a, 904a, 1004a have corresponding square, pentagon, and star shapes. Other shapes are possible.

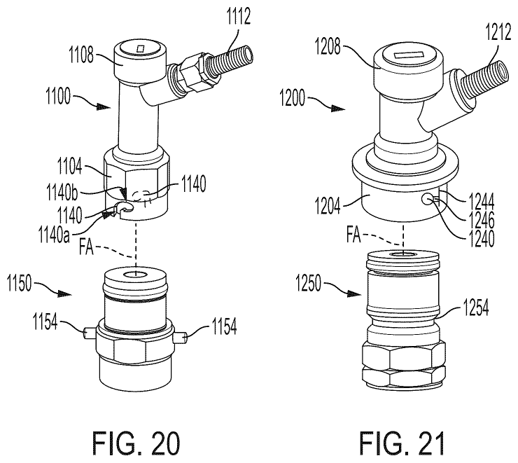

FIGS. 20 and 21 illustrate alternate fill adapter assemblies 1100, 1200 with differing connection mechanisms (e.g., other than the threads 308d, 324a, 608d, 624a) for permitting or inhibiting connection adapters 1104, 1204 to different connectors 1150, 1250 of the system 400.

With reference to FIG. 20, the adapter 1104 of the fill adapter assembly 1100 has an interlock slot 1140, and the connector 1150 of the fill adapter assembly 1100 a pin 1154. Geometries of the adapter 1104, connector 1150, interlock slot 1140, and pin 1154 are selected such that fill adapter assemblies 1100 are selected such that only appropriate fill adapter assemblies 1100 are capable of being engaged to connectors 1150 of an appropriate group 458-474. In the illustrated embodiment, the adapter 1104 includes two interlock slots 1140, and the connector 1150 includes two pins 1154, each of which are arranged on opposite sides of the filling axis FA from one another. The interlock slots 1140 are shaped with an axially extending portion 1140a extending generally parallel with the filling axis FA and a circumferentially extending portion 1140b extending about the filling axis FA. As such, relative movement of the pin 1154 axially through the axially extending portion 1140a and then circumferentially through the circumferentially extending portion 1140b is required to lock the adapter 1104 and the connector 1150 to one another. The illustrated interlock slots 1140 are through-slots extending through a thickness of the adapter 1104 between inner and outer sidewalls thereof. In the illustrated embodiment, the pins 1154 are shaped as generally cylindrical protrusions extending radially outwardly from the filling axis FA. An outer diameter of the pins 1154 may be sized to permit or inhibit engagement with the interlock slots 1140. Additionally or alternatively, quantities and/or circumferential arrangement of the interlock slot(s) 1140 and pin(s) 1154 may be selected to permit or inhibit connection of the adapter 1104 with the connector 1150.

With reference to FIG. 21, the adapter 1204 of the fill adapter assembly 1200 has a ball retainer 1240 on an inner surface 1244 thereof. The ball retainer 1240 is biased inwardly toward the filling axis FA by a spring 1246. The connector 1250 of the fill adapter assembly 1200 has an exterior surface defining a profile 1254. Geometries of the adapter 1204, connector 1250, ball retainer 1240, and profile 1254 are selected such that only appropriate fill adapter assemblies 1200 are capable of being engaged to connectors 1250 of an appropriate group 458-474. Similarly, the force of the spring 1246 may be selected in concert with angles and shapes of the profile 1254 to permit or inhibit connection of the adapter 1204 with compatible or incompatible connectors 1250.

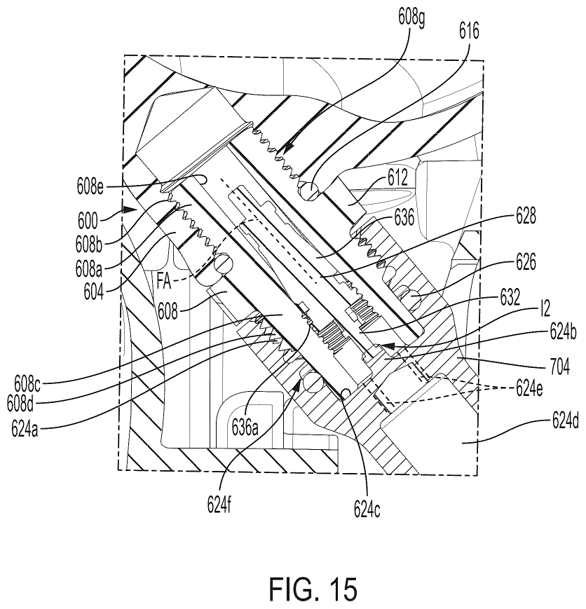

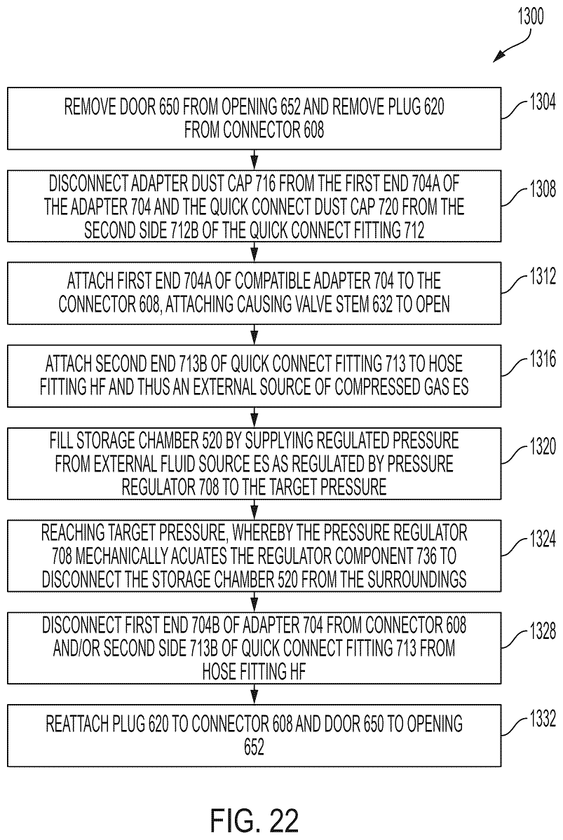

FIG. 22 illustrates a method of refilling 1300 the fastener driver 500. At step 1304, the door 350 is removed from the opening 652 by removing the fastener 654 and the plug 620 is unthreaded from the connector 608 by providing torque to the recess 608c. At step 1308, the adapter dust cap 716 and quick connect dust cap 720 are disconnected from the first end 704a of the adapter 704 and the opposite second side 712b of the quick-release fitting 712. At step 1312, the first end 704a of the adapter 704 is attached to the connector 608. Interference I2 (FIG. 15) between the adapter tip 624b and the valve stem 632 causes the valve stem 632 to open as the adapter 704 is attached to the connector 608. At step 1316, the second side 712b of the quick-release fitting 712 is attached to the hose fitting HF and thus the external source of compressed gas FS. At step 1320, the storage chamber 520 is filled by supplying regulated pressure from the external source of compressed gas FS as regulated by the pressure regulator 708 until the target pressure is reached at step 1324. When the target pressure is reached, spring 736a of the regulator component 736 is compressed by pressure in the first chamber 708d to close the first chamber 708d from the second chamber 708e and force flow through the opposite second chamber 708e into the bleed chamber 708f to exit the pressure regulator 708. In short, the pressure regulator component 736 is actuated, and the pressure regulator 708 is opened, permitting escape of excess compressed gas from the external source of compressed gas FS to atmosphere. By closing the first chamber 708d and forcing excess flow through the 708f/, the target pressure in the storage chamber 520 is set, and the storage chamber 520 is disconnected from the surroundings to inhibit leakage and the external source of compressed gas FS to inhibit overfilling. The user may, at step 1328, disconnect at least one of the first end 704a of the adapter 704 from the connector 608 and the second side 712b from the quick-release fitting 712 from the hose fitting HF. At step 1332, the plug 620 can once again be attached to the connector 608, and the door 650 may once again be attached to the opening 652. The method of refilling 1300 may be enacted with the piston 512 at its BDC position, however, the piston 512 may be at any position between BDC and TDC or at TDC.

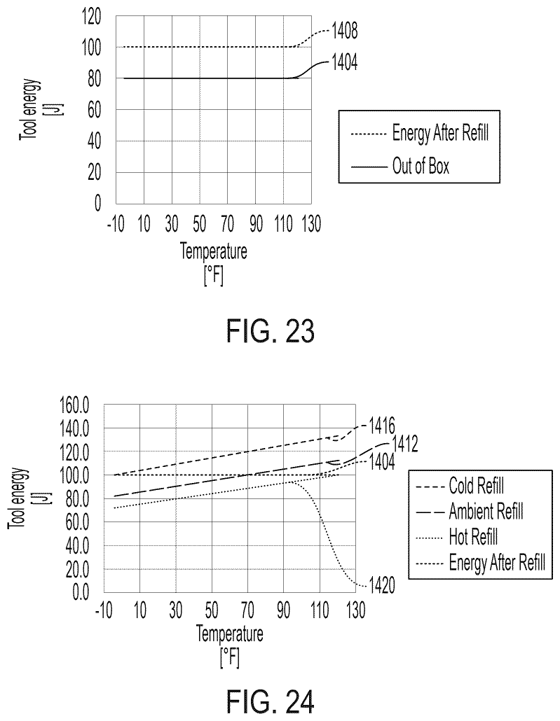

FIG. 23 illustrates tool energy over a wide range of temperatures with curve 1404 representing out of box tool energy, and curve 1408 representing tool energy after refill. Tool energy represents potential energy of the compressed gas in the storage chamber 120 at TDC and operable to drive a fastener. The fastener driver 100 may be shipped to the user with an out of box tool energy lesser than energy after refill at any given temperature. For example, curve 1404 illustrates 80 Joules (J) of out of box tool energy, and after conducting the method of refilling 1300, the user provides additional compressed gas from the external source of compressed gas FS to increase the tool energy to 100 J.

Temperature, pressure, and volume of a storage chamber 520 above a piston 512 are linked by the first law of thermodynamics, also known as the ideal gas law. When volume is constant, pressure is directly proportional to temperature. With the piston 512 stationary and an increase in ambient temperature occurs, pressure also increases. Conversely, with the piston 512 stationary and with a decrease in ambient temperature, pressure also decreases. When temperature is constant, pressure is inversely proportional to volume. When the piston 512 is moved from TDC to BDC, volume above the piston 512 increases, thus decreasing the pressure of the compressed gas above the piston 512. When the piston 512 is moved from BDC towards TDC, volume above the piston 512 decreases, thus increasing the pressure of the compressed gas above the piston 512.

FIG. 24 illustrates tool energy over a wide range of temperatures with curves 1412, 1416, 1420 representing tool energy at ambient, cold, and hot refill temperatures, respectively. Curve 1412 represents energy of the fastener driver 100 as refilled by the user at an ambient temperature (e.g., 70 degrees Fahrenheit). Since the storage chamber 120 is entirely enclosed after refilling at the ambient temperature, moving the fastener driver 100 from the ambient temperature refilling environment to a colder temperature environment (e.g., less than 70 degrees Fahrenheit) will decrease pressure of the compressed gas within the storage chamber 120 and thus decrease the tool energy of the fastener driver 100. Conversely, moving the fastener driver 100 from the ambient temperature refilling environment to a hotter temperature environment (e.g., greater than 70 degrees Fahrenheit) will increase pressure of the compressed gas within the storage chamber 120 and thus increase the tool energy of the fastener driver 100. Similarly, curve 1416 represents energy of the fastener driver 100 as refilled by the user at a cold refill temperature (e.g., 55 degrees Fahrenheit or less), and curve 1420 represents energy of the fastener driver 100 as refilled by the user at a hot refill temperature (e.g., 90 degrees Fahrenheit). These curves 1416, 1420 show that refilling at non-ambient temperatures result in over-energizing or under-energizing the fastener driver 100 when the fastener driver 100 is later returned to an ambient temperature, in comparison to an ambient temperature refill (i.e., when the fastener driver 100 is refilled at an ambient temperature).

Curve 1416 illustrates that after a cold refill, the fastener driver 100 may be moved to a high temperature environment, such as a 120-degree Fahrenheit environment, and due to the temperature rise, the pressure may increase to provide tool energy of approximately 130 J, which is 30% higher than the target tool energy of 100 J. Curve 1420 illustrates that after a hot refill, the fastener driver 100 may be moved to a low temperature environment, such as a −7 degree Fahrenheit environment, and due to the temperature drop, the pressure may decrease to provide tool energy of approximately 70 J, which is 30% lower than the target tool energy of 100 J.

The fastener drivers 100, 500 may have an adaptive refill mode in which the piston 112 is held at a refill position somewhere between BDC and TDC, instead of at BDC. An infinite number of partially refill positions between BDC and TDC are possible. The refill position may differ from the standby position. The same fastener drivers 100, 500 may also be capable of being refilled with the piston 112 at BDC in a BDC refill mode. The adaptive refill mode may take advantage of the ideal gas law relationship. For example, in cold refilling environments, the piston 112 may be raised to a refill position between BDC and TDC to decrease the volume above the piston 112 to counteract the low temperature and simulate a higher ambient temperature before filling. As a result, over-energizing and under-energizing is mitigated, as well as energy loss over time (which is especially apparent when fastener drivers 100, 500 are refilled in cold environments).

As discussed above with regard to the user interfaces 136, 536, operating modes of the fastener driver 100, 500 may be switched by actuating the user input mechanism 140, 540. In some embodiments, the same user input mechanism 140, 540 may be actuated to shift an operating mode of the fastener driver 100, 500 to the adaptive refill mode. With reference to FIGS. 13 and 14, the fastener driver 500 includes a refill mode button 1504 separate from the user interface 536. The illustrated refill mode button 1504 is positioned within the handle portion 552a of the housing 552 and is uncovered upon removal of the door 650. Optionally, the door 650 may be dimensioned such that the refill mode button 1504 is depressed when the door 650 is connected to the opening 652 and retracted when the door 650 is removed from the opening 652. The refill mode button 1504 is electrically coupled to the controller 146 to communicate when the refill mode button 1504 is actuated, and the controller 146 is operable to shift operating mode of the fastener driver 500 to the refill mode or the adaptive refill mode according to actuation of the refill mode button 1504. In other words, the refill mode button 1504 may send an indication to the controller 546 that the refill mode button 1504 has been actuated, indicative of the door 650 being removed. In other embodiments, the refill mode button 1504 may be positioned elsewhere on the fastener driver 500. For example, the refill mode button 1504 may be on the user interface 136, 536. In other embodiments, functionality of the refill mode button 1504 may be integrated or otherwise controlled by actuation of the user interface 136, 536 such that the refill mode may be shifted by actuation of the user input mechanism 140, 540.

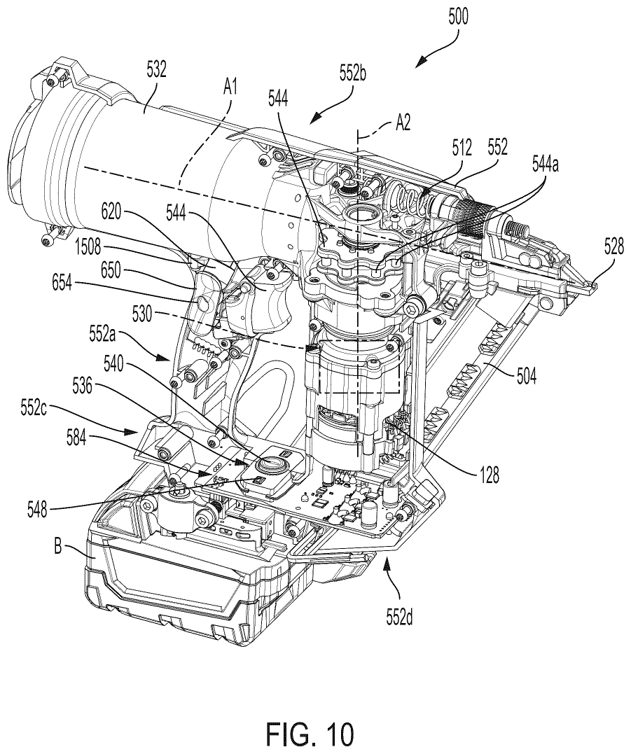

With reference to FIGS. 10 and 13, the fastener driver 500 may include a temperature sensor 1508. The temperature sensor 1508 is electrically coupled to the controller 546. The temperature sensor 1508 can measure at least one of ambient air temperature surrounding the fastener driver 500 and a temperature of the compressed fluid within the storage chamber 520. The controller 546 may utilize data or signals from the temperature sensor 1508 to calculate a fill position of the piston 512 based on the sensed temperature. The fill position of the piston 512 may be BDC, TDC, or between BDC and TDC.

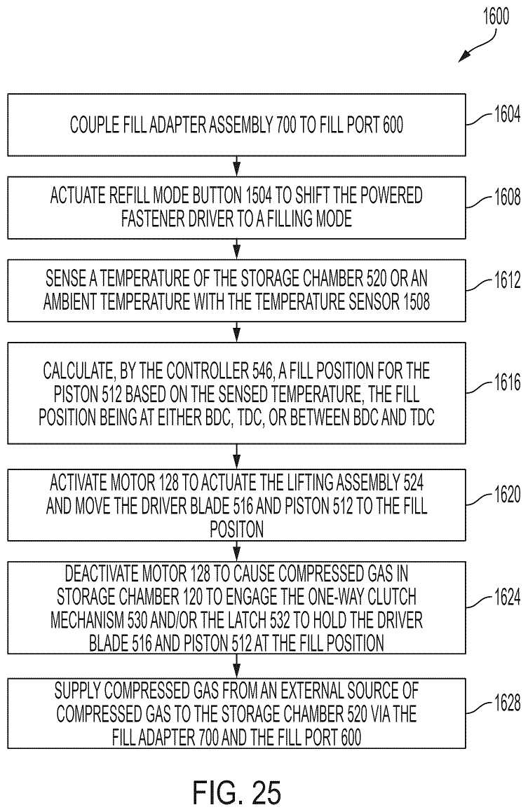

FIG. 25 illustrates an adaptive refill method 1600. At step 1604, the fill adapter assembly 700 is coupled to the fill port 600. At step 1608, the refill mode button 1504 is actuated, and the fastener driver (e.g., 100, 500) is shifted to a filling mode, for example, the adaptive refill mode. The term filling mode (e.g., service mode) may generally refer to a mode in which the fastener driver 100 holds the driver blade 116 at a fill position at BDC or between BDC and TDC to conduct a fill operation of the storage chamber 120 with compressed gas from the external source ES. Filling mode may be one example of a service mode in which some type of service is to be conducted on the fastener driver 100 (e.g., service may be other types of service other than filling). In contrast, in an operating mode of the fastener driver 100, (e.g., a normal operating mode such as a semi-automatic firing mode or bump-fire mode), the driver blade 116 is capable of moving between BDC and TDC during consecutive fastener driving operations. At step 1612, the temperature sensor 1508 senses a temperature of the storage chamber 520 or an ambient temperature of the fastener driver 100, 500. At step 1616, the controller 546 calculates a fill position for the piston 512 based on the sensed temperature. The fill position may be any of BDC, TDC, or anywhere between BDC and TDC. At step 1620, the motor 128 is activated to actuate (i.e., rotate) the lifting assembly 524 and move the driver blade 516 and piston 512 to the fill position. At step 1624, the motor 128 is deactivated, and compressed gas in the storage chamber 120 presses against the piston 512, whereby torque is transmitted via the lifting assembly 524 to engage the one-way clutch mechanism 530. In the illustrated embodiment, the one-way clutch mechanism 530 is engaged to hold the driver blade 516 and piston 512 in the fill position. Optionally, the latch 532 may be moved toward its latched position whereby the latch 532 is aligned with a latch tooth 516b to inhibit driving of the driver blade 516. In other embodiments, the latch 532 may be moved to its latched position with the latch 532 engaging one of the latch teeth 516b to inhibit driving of the driver blade 516. As such, the latch 532 and the one-way clutch mechanism 530 may both be considered blade engaging mechanisms capable of holding the driver blade 516 in the fill position. At step 1628, compressed gas from the external source of compressed gas FS is supplied to the storage chamber 520 via the fill adapter assembly 700 and the fill port 600. The compressed gas may be regulated from the pressure regulator 708.

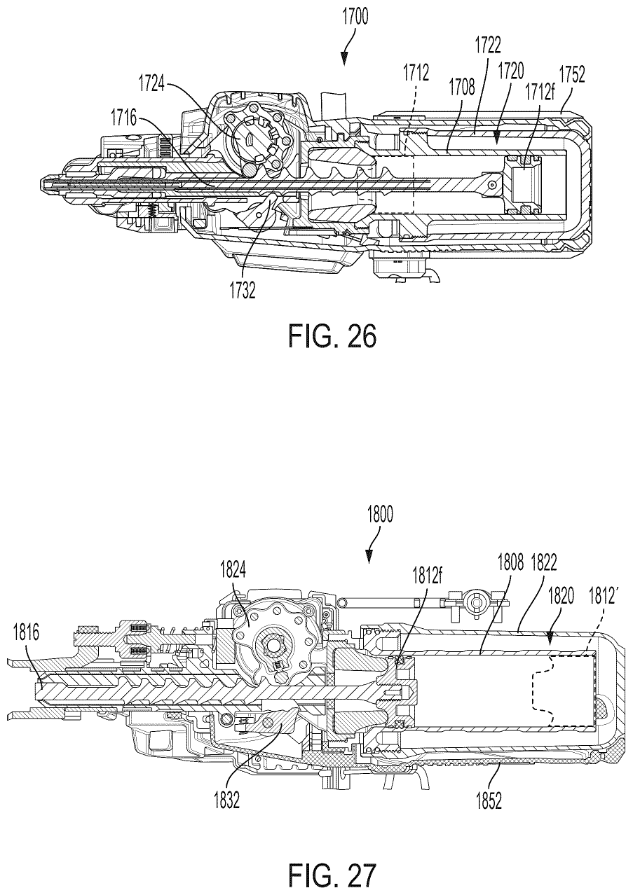

FIG. 26 illustrates another exemplary gas spring-powered fastener driver 1700 like the fastener driver 100 but with components thereof in the ‘1700’ series of reference numerals. The fastener driver 1700 is illustrated with its piston 1712 in an adaptive fill position 1712f between BDC (as illustrated by reference numeral 1712) and TDC (at the right side of cylinder 1708 as viewed in FIG. 26). FIG. 27 illustrates another exemplary gas spring powered fastener driver 1800 like the fastener driver 100 but with components thereof in the ‘1800’ series of reference numerals. The fastener driver 1800 is illustrated with its piston 1812 in an adaptive fill position 1812f at BDC. Depending on ambient temperature of the fastener driver 1800, the piston 1812 may be moved to and held at a position between BDC and TDC (as illustrated by piston 1812′).

FIGS. 28 and 29 illustrate an exemplary one-way clutch mechanism 130, 530 as part of a transmission 1900 between the motor 128 and the lifting assembly 124. The transmission 1900 includes an input 1904 (i.e., a motor output shaft), and is coupled via an output pinion 1908 to the lifting assembly 124. The transmission 1900 is oriented along a transmission axis 1912. Multiple planet gears 1916 are coupled to the input 1904, which functions as a sun gear. A ring gear 1920 of the transmission 1900 includes a toothed interior peripheral portion and an adjacent cylindrical interior peripheral portion 1928. The planet gears 1916 are rotatably supported upon a carrier 1932 for relative rotation therewith, and the planet gears 1916 are engageable with (enmeshed with) the toothed interior peripheral portion 1924.

With continued references to FIGS. 28 and 29, the one-way clutch mechanism 130, 530 also includes a plurality of lugs 1936 defined on an outer periphery of the carrier 1932. In addition, the one-way clutch mechanism 130, 530 includes a plurality of rolling elements 1940 biased by springs 1942 and engageable with the respective lugs 1936, and a ramp 1944 adjacent each of the lugs 1936 along which the rolling element 1940 is moveable. Each of the ramps 1944 is inclined in a manner to displace the rolling elements 1940 farther from the transmission axis 1912 of the carrier 1932 as the rolling elements 1940 move further from the respective lugs 1936. With reference to FIG. 28, the carrier 1932 of the one-way clutch mechanism 130, 530 is in the same planetary stage of the transmission 1900 as the ring gear 1920. The rolling elements 1940 are engageable with the cylindrical interior peripheral portion 1928 of the ring gear 1920 in response to an application or torque on the output pinion 1908 in the second rotational direction (i.e., as the rolling elements 1940 move along the ramps 1944 away from the respective lugs 1936).

In operation of the one-way clutch mechanism 130, 530, the rolling elements 1940 are maintained in engagement with the respective lugs 1936 in the first rotational direction (i.e., counter-clockwise from the frame of reference of FIG. 29) of the output pinion 1908. However, the rolling elements 1940 move away from the respective lugs 1936 in response to an application of torque on the output pinion 1908 in an opposite, second rotational direction (i.e., clockwise from the frame of reference of FIG. 29). More specifically, when the output pinion 1908 rotates a small amount (e.g., 1 degree) in the second rotational direction, the rolling elements 1940 roll away from the respective lugs 1936, along the ramps 1944, and engage the cylindrical interior peripheral portion 1928 on the ring gear 1920 to thereby prevent further rotation of the output pinion 1908 in the second rotational direction. In other words, the one-way clutch mechanism 130, 530 prevents the transmission 1900 from applying torque to the motor 128, which might otherwise back-drive or cause the motor 128 to rotate in a reverse direction, in response to an application of torque on the output pinion 1908 in an opposite, second rotational direction (e.g., from the compressed gas in the storage chamber 120). The one-way clutch mechanism 130, 530 also prevents the motor 128 from being back-driven by the transmission 1900 when the driver blade 116, 516 is being held in the ready position and the adaptive refill position. The one-way clutch mechanism 130, 530 allows for the infinite number of adaptive refill positions of the piston 112 between TDC and BDC since no discrete positions of engagement are required. However, it is possible that the latch 532 may be utilized to hold the driver blade 116 and thus the piston 112 in a plurality of discrete refill positions corresponding with locations of the latch teeth 116b along the driver blade 116.

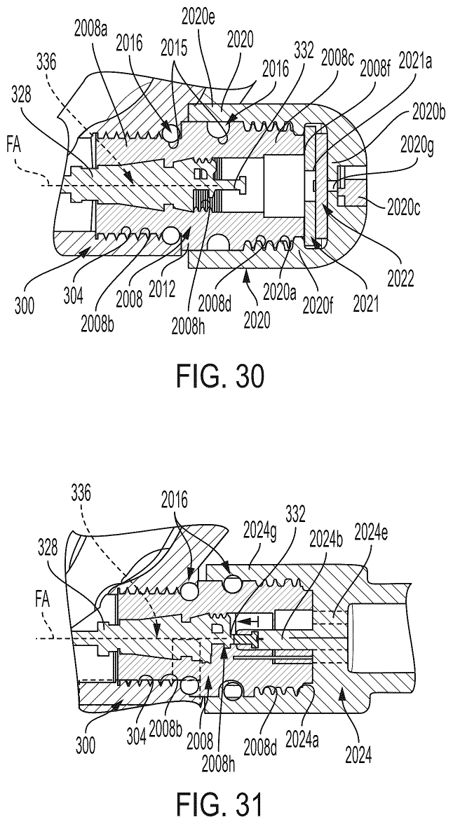

FIG. 30 illustrates an alternate embodiment connector 2008 engaged with the fill port 300, and an alternate plug 2020 engaged with the connector 2008. The connector 2008 has features similar to the connector 308 including a tool-side 2008a, tool-side threads 2008b, outer-side 2008c and outer-side threads 2008d, bore 2008e, outer axial end surface 2008f, outboard axial end surface 2008f, and radial outer surface 2008g. The bore 2008e includes interior threads 2008h. The connector 2008 also includes a shoulder 2012 for abutment against the fill port 300 when the connector 2008 is fully seated therein. The connector 2008 further defines recesses 2015 at an outer radial surface thereof which receive o-rings 2016. The illustrated embodiment includes two recesses 2015 provided on opposite sides of the shoulder 2012. The plug 2020 has features like the plug 320 with components thereof annotated with corresponding ‘2020’ reference numerals except for the O-ring receptacle 320d. Rather than the O-ring receptacle 320d, the plug 2020 includes an annular portion 2020e forward of internal threads 2020a. The annular portion 2020e engages the o-ring 2016 in the recess 2015 outboard of the shoulder 2012. The plug 2020 further includes a rib 2020f that extends radially inwardly toward the filling axis FA at an axial position near the outer axial end surface 2008f of the connector 2008.

When the plug 2020 is coupled to the connector 2008, a face seal 2021 and backer 2022 are compressed between the outer axial end surface 2008f of the connector 2008 and an end wall 2020b of the plug 2020. The face seal 2021 provides a secondary seal in addition to the valve 328 for inhibiting any incidental leakage from the valve 328 from being passed to the atmosphere. Further, the o-ring 2016 pressing against the annular portion 2020e acts as a tertiary seal inhibiting any incidental leakage from the valve 328 from being passed to the atmosphere. In some embodiments, the backer 2022 may be made of a polyoxymethylene (e.g., a type of thermoplastic polymer commonly known as acetal, i.e., POM) material designed to melt in a burning scenario and release air though a small hole 2020g in the plug 2020 adjacent a non-circular recess 2020c thereof. The face seal 2021 has a hole 2021a in a center thereof designed to allow the seal 2021 to allow air to escape through the hole 2020g if the backer 2022 fails.

FIG. 31 illustrates an alternate adapter 2024 engaging the connector 2008. The adapter 2024 has features like the adapter 324 annotated with corresponding ‘2024’ reference numerals except for the O-ring receptacle 324f. Rather than the O-ring receptacle 324f, the adapter 2024 includes an annular portion 2024g forward of the internal threads 2024a. The annular portion 2024f engages the o-ring 2016 in the recess 2015 outboard of the shoulder 2012. The adapter 2024 and plug 2020 each function in a similar manner to the above-described plug 320 and adapter 324. In sum, the plug 2020 is connected to the connector 2008 and thus the fill port 300 during normal use of the fastener driver 100, and the adapter 2024 is connected to the connector 2008 and thus fill port 300 during a refilling operation of the fastener driver 100.

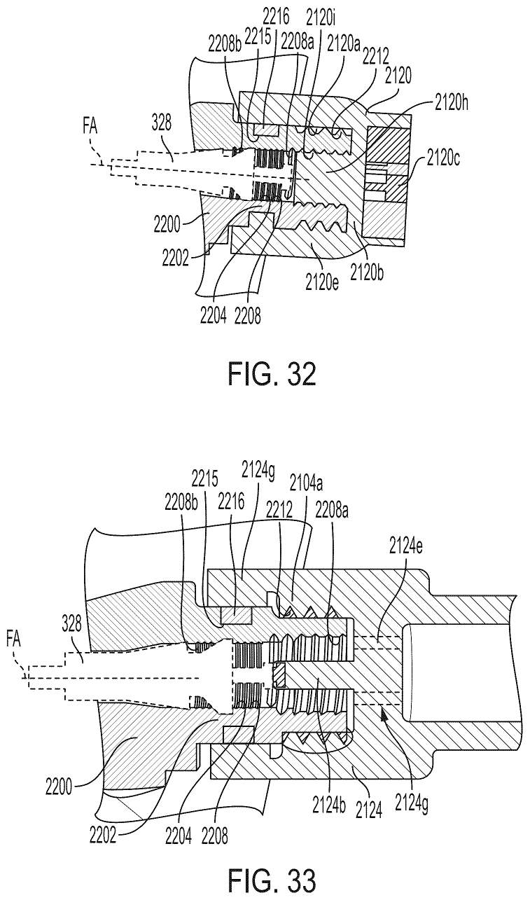

FIG. 32 illustrates an alternate embodiment with a plug 2120 engaged directly with a fill port 2200 defining a tank stem 2202. The fill port 2200 and tank stem 2202 define a bore 2204 with internal threads 2208. The bore 2204 includes a first group of internal threads 2208a on an outboard side of the fill port 2200 (right side of FIG. 32) and a second group of internal threads 2208b on an inboard side of the fill port 2200 (left side of FIG. 32). The groups of internal threads 2208a, 2208b differ in thread pattern and/or diameter. In other embodiments, the internal threads 2208 may not be split between two groups. The first group of internal threads 2208a engages the valve 328. The tank stem 2202 includes outer threads 2212 and defines a receptacle 2215 that receives an o-ring 2216. The receptacle 2215 is on an inboard side of the fill port 2200 in comparison to the outer threads 2212 (i.e., the receptacle is to the left of the threads as viewed in FIG. 32).

The plug 2120 includes internal threads 2120a, an end wall 2120b, and an annular portion 2120e forward of the internal threads 2120a. The internal threads 2120a of the plug 2120 are engageable with the outer threads 2212 of the tank stem 2202. The plug 2120 further includes a post 2120h inside of and spaced from the annular portion 2120e. The post 2120h includes outwardly facing threads 2120i engageable with the first group of internal threads 2208a. Connection between the post 2120h and the first group of internal threads 2208a as well as the internal threads 2120a with the outer threads 2212 supplement the seal formed between o-ring 2216 and the annular portion 2120e.

FIG. 33 illustrates an alternate adapter 2124 engaging the tank stem 2202. The adapter 2124 has features like the adapter 2024 annotated with corresponding ‘2124’ reference numerals. Namely, the adapter 2124 includes an annular portion 2124g forward of internal threads 2124a. The annular portion 2024f engages the o-ring 2216 in the recess 2215. The adapter 2124 and plug 2120 each function in a similar manner to the above-described plug 320 and adapter 324. In sum, the plug 2120 is connected to the fill port 2200 during normal use of the fastener driver 100, and the adapter 2124 is connected to the fill port 2200 during a refilling operation of the fastener driver 100. The adapter 2124 includes an adapter tip 2124b with an axial length parallel to the filling axis FA longer than that of the post 2120h such that the post 2120h does not actuate the valve 328 when the plug 2120 is fully coupled to the tank stem 2202, and the adapter tip 2124b actuates the valve 328 to its open positioned when the 2124 is fully coupled to the tank stem 2202.

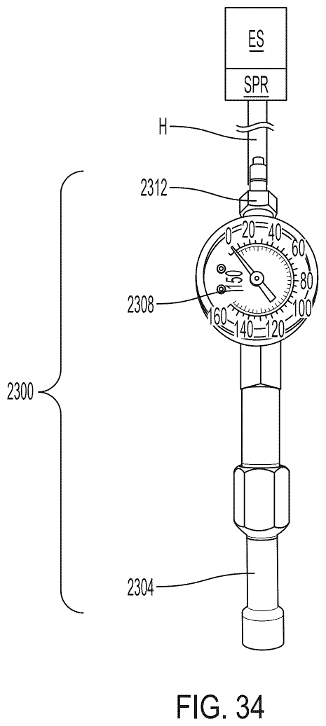

FIG. 34 illustrates an alternate fill adapter assembly 2300 (like the fill adapter assembly 700, FIG. 14). The fill adapter assembly 2300 includes a tool adapter 2304 configured to engage a fill port 300, a pressure gauge 2308 capable of displaying instantaneous pressure of the connected storage chamber 120, and a hose adapter 2312 connecting the tool adapter 2304 and pressure gauge 2308 to the hose H and fluid supply FS. The illustrated pressure gauge 2308 is an analog pressure gauge with a physical needle that moves (more specifically, rotates) relative to indicia to indicate to a user an instantaneous pressure of the storage chamber 120. The pressure gauge 2308 may be arranged in series or parallel with the fluid supply line via the hose H and external source of compressed gas FS. Alternatively, the pressure gauge 2308 may be a digital pressure gauge with onboard electrical components and/or a display for indicating to a user instantaneous pressure of the storage chamber 120. The tool adapter 2304 may be arranged in a manner similar to any of the aforementioned adapters 324, 704, 804, 904, 1004, 1104, 1204, 2024, 2124 or the like. A first end of the hose adapter 2312 is coupled to the tool adapter 2304, and an opposite second end of the hose adapter 2312 is connected to the hose H. Optionally, one or both ends of the hose adapter 2312 may be fixed to either the tool adapter 2304 and/or the hose H. In any case, the tool adapter 2304 is engageable with a corresponding fill port (e.g., the fill port 300) to fluidly couple the external source of compressed gas FS to the storage chamber 120.

In contrast to the fill adapter assembly 700 (FIG. 14), the alternate fill adapter assembly 2300 (FIG. 34) does not include a pressure regulator 708. The fill adapter assembly 2300 is devoid of a pressure regulator other than the source pressure regulator SPR. However, the external source of compressed gas FS (e.g., a compressor) may include a source pressure regulator SPR on a source-side of the hose H (e.g., adjacent the compressor) opposite to the tool-side. The source pressure regulator SPR may be adjustable to a desired pressure setting to step down pressure of the external source of compressed gas FS to an acceptable level for passage to refill the storage chamber 120. The alternate fill adapter assembly 2300 may optionally further include a one-way valve permitting ingress of filling gas into the storage chamber 120 and inhibiting egress of gas from escaping the storage chamber 120. The alternate fill adapter assembly 2300 may optionally further include a pressure relief valve (in other words, a pressure release valve) for permitting egress of gas in the alternate fill adapter assembly 2300. Further, the tool adapter 2304 may be modified or replaced to engage different types of valves valve 328 of the fill port 300.

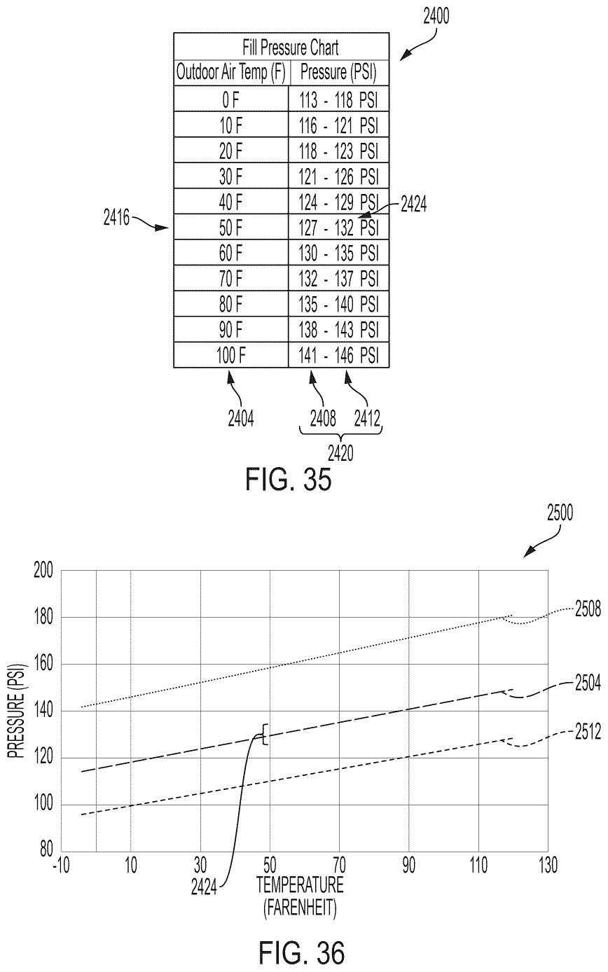

FIG. 35 depicts an exemplary fill pressure chart 2400 for an exemplary fastener driver 100 with an ambient temperature column 2404, a lower bound pressure column 2408, an upper bound pressure column 2412, and a plurality of rows 2416 each representing differing ambient temperatures. The fill pressure chart 2400 may be provided with (e.g., in a product manual, on-tool indicator, etc.) or otherwise be made accessible to the user (e.g., via an on-tool display or indicator or on a separate device display or indicator such as a cell phone) of the fastener driver 100 for user consultation before conducting a refill thereof. The lower bound pressure column 2408 and upper bound pressure column 2414 together define an acceptable refill pressure range 2420 for the corresponding ambient temperature. For example, in the illustrated embodiment, at 50 degrees Fahrenheit (e.g., approximately 10 degrees Celsius), the fill pressure chart 2400 can be consulted to inform the user to refill the fastener driver 100 with a pressure within an exemplary acceptable refill pressure range 2424 of equal to or at least 127 pounds per square inch (e.g., approximately 8.64 atmospheres) as listed in the lower bound pressure column 2408, and equal to or at most 132 pounds per square inch (e.g., approximately 8.98 atmospheres) as listed in the upper bound pressure column 2412. The exemplary fill pressure chart 2400 illustrates exemplary acceptable refill pressure ranges 2420. Other ranges are possible, especially since similar fill pressure charts 2400 may be made for other fastener drivers (or other groups 458-474 of fastener drivers 100) of the fastener driver system 400 (FIG. 8).

FIG. 36 illustrates a graph 2500 of tool pressure over a wide range of temperatures. Curves 2504, 2508, 2512 represent target fill pressure, high tolerance pressure, and lower tolerance pressure conditions at various temperatures. The high tolerance pressure and lower tolerance pressure represent accuracy of the source pressure regulator SPR. Operating conditions of some types of pressure regulators (e.g., source pressure regulator SPR) may supply gas between 18 pounds per square inch lesser than target fill pressure and 32 pounds per square inch greater than target fill pressure. Other tolerances are possible. The target fill pressure curve 2504 generally correlates with the ambient refill curve 1412 of FIG. 24. The high tolerance pressure curve 2508 is drawn at a pressure 32 pounds per square inch greater than the target fill pressure curve 2504. The lower tolerance pressure curve 2512 is drawn at a pressure 18 pounds per square inch lesser than the target pressure curve 2504. Accuracy of storage chamber 120 is important to providing appropriate amounts of energy of the fastener driver 100. Since the source pressure regulator SPR is not accurate enough to, itself, meet the acceptable refill pressure range 2420, the user may consult the fill pressure chart 2400 and the pressure gauge 2308 throughout a filling process, and the user may disconnect the alternate fill adapter assembly 2300 from the fastener driver 100 or otherwise stop filling the storage chamber 120 when the acceptable refill pressure range 2420 is reached. FIG. 36 further illustrates the exemplary acceptable refill pressure range 2424 as being between only a portion of the curves 2508, 2512.

During a refill operation of the fastener driver 100 with the alternate fill adapter assembly 2300, a user may consult an ambient air thermometer and the fill pressure chart 2400 to determine the ambient air temperature. Indexing for ambient air temperature, the user determines the acceptable refill pressure range 2420 and may adjust the source pressure regulator SPR to correspond with a pressure within or above the acceptable refill pressure range 2420. The user then initiates filling of the storage chamber 120 and monitors the pressure gauge 2308 throughout the filling process. Once the acceptable refill pressure range 2420 is reached, the user may disconnect the alternate fill adapter assembly 2300 from the fastener driver 100 or otherwise stop filling the storage chamber 120. The alternate fill adapter assembly 2300 avoids cost of providing a pressure regulator 708 adjacent the fastener driver 100, and instead utilizes existing source pressure regulators SPR and user monitoring of the pressure gauge 2308 to ensure acceptable refill pressure ranges 2420 are met at the instantaneous ambient temperature.

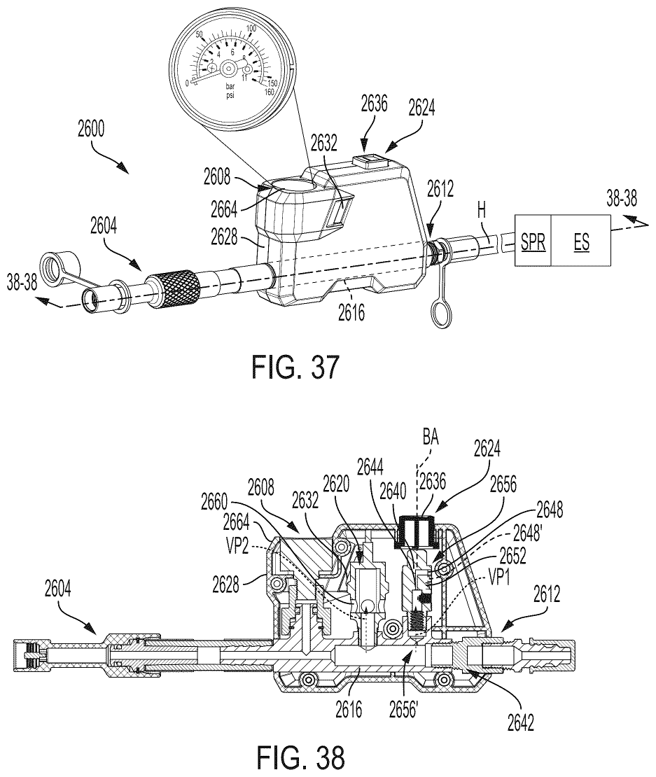

FIGS. 37 and 38 illustrate another fill adapter assembly 2600 like the fill adapter assembly 2300 (FIG. 34), with like components indicated with reference numerals in the ‘2600’ series. The fill adapter assembly 2600 includes a fill adapter manifold 2616 that is connected to a pressure gauge 2608, an overflow relief valve 2620, and a slow bleeder valve 2624. At least a portion of the pressure gauge 2608, overflow relief valve 2620, and slow bleeder valve 2624 are positioned within a fill adapter housing 2628, which includes a vent hole 2632. The vent hole 2632 permits compressed gas discharged from either or both of the overflow relief valve 2620 and slow bleeder valve 2624 and into the fill adapter housing 2628 to be discharged therethrough and exhausted to the atmosphere.

As described above with respect to the alternate fill adapter assembly 2300 (FIG. 34), the fill adapter assembly 2600 includes a tool adapter 2604 configured to engage a fill port 300 and a hose adapter 2612 as described above with respect to the fill adapter assembly 2300 and the quick-release fitting 712 of the fill adapter assembly 700. The tool adapter 2604 and hose adapter 2612 function as couplings engaged with the fill adapter manifold 2616 and configured to engaged with the fill port 300 and an external fluid supply (e.g., the external source of compressed gas ES), respectively, for passing fluid from the external source and into the fill port 300. The tool adapter 2604 may be arranged in a manner similar to any of the aforementioned adapters 324, 704, 804, 904, 1004, 1104, 1204, 2024, 2124 or the like.

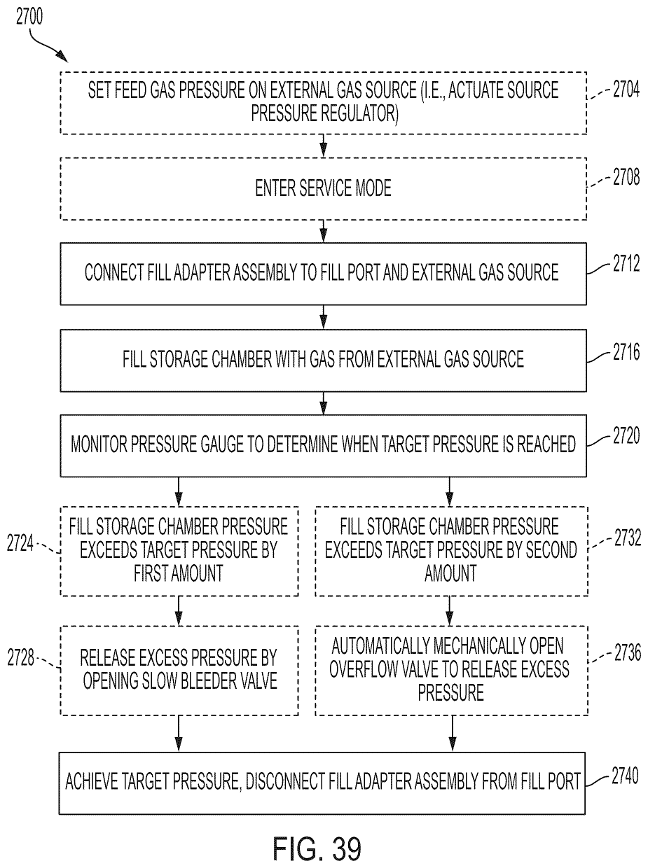

The fill adapter assembly 2600 (FIG. 38) does not include a pressure regulator that steps down the pressure of the filling gas to a target pressure (or any intermediate pressure between the target pressure and a pressure from the external source ES, e.g., as stepped down by the source pressure regulator SPR) before being introduced into the connected cylinder 108. Rather, compressed gas from the external source ES (unregulated or optionally regulated by the source pressure regulator SPR) may be passed through the fill adapter assembly 2600 without being further stepped down in pressure. The fill adapter assembly 2600 relies on the user to consult a fill pressure chart 2400 (FIG. 35) corresponding with the powered fastener driver to be filled to determine an appropriate fill pressure, and to halt filling before an overpressure condition occurs. During a refill process, as described below with respect to FIG. 39, the user monitors the pressure gauge 2608 during filling, and may halt filling when the appropriate fill pressure is reached. Filling may be halted by actuation of one or more valves in the conduit between the external source ES and the fill port 300. Such a valve may be the physically positioned on the fill adapter assembly 2600 and may be actuated by a user. The fill adapter assembly 2600 is devoid of a pressure regulator other than the source pressure regulator SPR. The fill adapter assembly 2600 may optionally further include a one-way valve, for example, a check valve 2642 (FIG. 38) permitting ingress of filling gas into the storage chamber 120 and inhibiting egress of gas from escaping the storage chamber 120. Further, the tool adapter 2604 may be modified or replaced with another tool adapter 2604 to engage different types of valves 328 of the fill port 300 or to prevent errors in connecting an inappropriate fill adapter assembly 2600 to the fill port 300 as described above with respect to the powered fastener driver system 400 and groups 458, 462, 466, 470, 474 thereof.

With reference to FIG. 37, the vent hole 2632 of the fill adapter housing 2628 permits any gas vented by either or both of the overflow relief valve 2620 and the slow bleeder valve 2624 to the environment of the fill adapter assembly 2600 (e.g., to the atmosphere). The vent hole 2632 may provide a relatively large cross-sectional area through which gas can vent such that the vented gas can freely escape the fill adapter housing 2628 without pressurizing the fill adapter housing 2628.

With reference to FIG. 38, the slow bleeder valve 2624 includes a button 2636, a bleeder valve body 2640 with a bleed path 2644, and a bleed cover 2648 which is biased by a spring 2652. In the illustrated embodiment, the bleeder valve body 2640 defines the relief hole 2656. Alternatively, an alternate relief hole 2656′ may be formed in the fill adapter manifold 2616. In the illustrated embodiment, the overflow relief valve 2620 and slow bleeder valve 2624 define separate valve bodies but are each connected to the fill adapter manifold 2616. In other embodiments, the overflow relief valve 2620 and slow bleeder valve 2624 could be combined into a single component including a single valve body and two movable valve components for example, including a combined valve body, the bleed cover 2648, and a valve component associated with the functionality of the overflow relief valve 2620. The button 2636 is linked with movement of the cover 2648 to facilitate opening and closing of the bleeder valve 2624. The button 2636 may be actuated (e.g., depressed) by a user to facilitate slow and controlled bleed of excess pressure from the connected cylinder 108 if inadvertently overfilled with compressed gas. In the illustrated embodiment, the button 2636 is depressed along a button axis BA, and the bleed cover 2648 also moves along the button axis BA, although other arrangements are possible. Such an overpressure condition may be in excess of the pressure value indicated in the upper bound pressure column 2412 (FIG. 35) for the outdoor air temperature at the time of filling but less than a threshold (i.e., maximum desired) pressure value.

The bleed path 2644 extends from the fill adapter manifold 2616 and through the bleeder valve body 2640 and is selectively opened and closed to the interior of the housing by actuation of the button 2636 and corresponding movement of the bleed cover 2648 to its opened position. Reference numeral 2648′ illustrates the bleed cover 2648 in its open position whereby at least a portion of the bleed path 2644 is exposed to the fill adapter housing 2628. An end of the bleed path 2644 opposite the fill adapter manifold 2616 terminates at a relief hole 2656. The relief hole 2656 defines a cross-sectional flow area through which vented compressed gas is released into the fill adapter housing 2628.

The relief hole 2656 may define a cross-sectional flow area of less than 1 square millimeter. The relief hole 2656 may define a cross-sectional flow area of less than 0.1 square millimeters. The relief hole 2656 may define a cross-sectional flow area of less than 0.01 square millimeters. The relief hole 2656 may define a circular cross-sectional shape having a diameter of 0.1 millimeters or less. For example, the illustrated relief hole 2656 defines a 0.025 millimeter diameter and thereby approximately 0.000491 square millimeters of cross-sectional flow area. Upon actuation of the button 2636, gas within the fill adapter manifold 2616 (e.g., excess compressed gas from the connected cylinder 108) may be vented along vent path VP1 through the bleed path 2644, relief hole 2656, and vent hole 2632 to the surroundings of the fill adapter assembly 2600 (e.g., the atmosphere).

The overflow relief valve 2620 may automatically open from a closed state to an open state in response to the pressure of compressed gas within the manifold 2616 (and the connected cylinder 108) exceeding a predetermined threshold or maximum desired value. When the overflow relief valve 2620 opens, compressed gas flows through one or more relief holes 2660 and a second vent path VP2 between the fill adapter manifold 2616 and the fill adapter housing 2628. Like the compressed gas discharged from the slow bleeder valve 2624, the compressed gas discharged from the overflow relief valve 2620 is vented through vent hole 2632 to the surroundings of the fill adapter assembly 2600 (e.g., the atmosphere).

The relief holes 2660 in the overflow relief valve 2620 define a cross-sectional flow area larger than the relief hole 2656 of the slow bleeder valve 2624. The illustrated overflow relief valve 2620 includes a plurality of (e.g., four) relief holes 2656 arranged circumferentially about the overflow relief valve 2620.

The illustrated fill adapter assembly 2600 is arranged in an in-line relationship with the hose adapter 2612, fill adapter manifold 2616, and tool adapter 2604 extending along a common direction. Other arrangements are possible. The illustrated fill adapter housing 2628 surrounds at least a portion of the fill adapter manifold 2616 and at least one of the overflow relief valve 2620 and slow bleeder valve 2624. The button 2636 protrudes from a top wall of the fill adapter housing 2628 (as viewed in FIG. 38). The hose adapter 2612 (which may be arranged as the above-described quick-release fitting 712) extends from a back wall of the housing 2628 (e.g., to the right of the housing 2628 as viewed in FIG. 38), with the hose adapter 2612 being configured to be fluidly connected to the external source of compressed gas ES. The tool adapter 2604 extends from a front wall of the housing 2628 (e.g., to the left of the housing 2628 as viewed in FIG. 38), where the tool adapter 2604 is attachable to the fill port 300. Finally, the fill adapter housing 2628 includes a hole 2664 through which the pressure gauge 2608 is visible.

FIG. 39 illustrates a filling method 2700 with use of the fill adapter assembly 2600. At optional step 2704, a feed gas pressure of the external gas source is set actuating a source-pressure regulator. At step 2708, a service mode of the fastener driver 100 is entered, including, optionally and for example, moving the piston 112 to BDC. At step 2712, a fill adapter assembly (e.g., fill adapter assembly 2600) is connected to the fill port 300 and to the external source of compressed gas FS. At step 2716, the storage chamber 120 is filled with gas from the external gas source ES. At step 2720, the fill operator visually monitors a pressure gauge (e.g., pressure gauge 2608) to determine when a target pressure (or any acceptable pressure in the refill pressure range 2420 for the given ambient temperature, FIG. 35) has been reached. At step 2724, the fill operator may determine by inspection of the pressure gauge 2608 that the pressure of the storage chamber 120 exceeds the target pressure by a first amount. At step 2728, the fill operator may release excess pressure from the storage chamber 120 by depressing the button 2636 and thereby opening the slow bleeder valve 2624. At step 2732, pressure of the storage chamber 120 exceeds the target pressure by a larger, second amount. At step 2736, the overflow relief valve 2620 automatically opens to release excess pressure at least down to the first amount, at which time the overflow relief valve 2620 may close and the slow bleeder valve 2624 may be actuated to further reduce the pressure to the target pressure (or at least to within the acceptable pressure in the refill pressure range 2420). At step 2740, after achieving the target pressure (or pressure within the acceptable pressure range), filling may be halted, the fill adapter assembly 2600 may be disconnected from the fill port 300, and the fastener driver 100 may continue normal use.

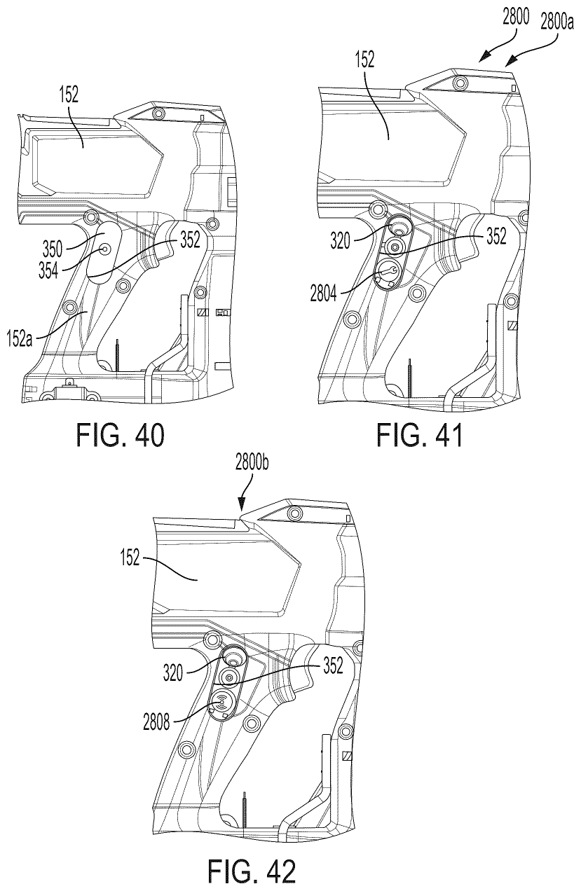

FIGS. 40-49 illustrate a plurality of mode switching systems 2800 configured to intuitively ease switching of the fastener driver 100 to a refill mode and avoid complex actions to transition the fastener driver 100 to a service mode, for example, for locating the piston 112 for conducting a fill or refill operation of the storage chamber 120. These features 2800 generally ease the operational steps and confusion involved with shifting the fastener driver 100 to service mode (e.g., for refilling).

FIG. 40 illustrates a housing 152 with a door 350 coupled to an opening 352 of the housing 152, more specifically, the handle portion 152a. The FIG. 40 door 350 is generally similar to but slightly elongated in comparison to the door 350 illustrated in FIG. 1.

FIG. 41 illustrates a first mode switching system 2800a including a user-actuatable service button 2804. The service button 2804 is positioned within the handle portion 152a of the housing 152 as covered and uncovered by movement of the door 350. The user-actuatable service button 2804 may be mounted on a printed circuit board within the handle portion 152a of the housing 152. The illustrated door 350 is entirely removable from the housing 152. However, in other embodiments, the door 350 may remain attached to the housing 152 yet movable (e.g., translated, slid, pivoted, etc.) relative to the opening 352 to cover and uncover the user-actuatable service button 2804. The door 350 and fastener 354 shield the service button 2804 from inadvertent actuation to inhibit inadvertently shifting the fastener driver 100 to the service mode during normal operation due to contact with external forces. When a tool operator suspects that the fastener driver 100 is operating with high or low pressure in the storage chamber 120, the product manual may be consulted, and the user may be instructed by the product manual to loosen the fastener 354 and move or remove the door 350 to at least partially uncover the service button 2804. The refill operator may be visually prompted (as well as prompted by the product manual) to depress the user-actuatable service button 2804 to shift the fastener driver 100 to the service mode before removing the plug 320 and connecting a fill adapter assembly 700 (or, fill adapter assembly 2300 or fill adapter assembly 2600) to the fill port 300. The service button 2804 is distinct from the user input mechanism 140 that is accessible from the exterior of the housing 152 to avoid unnecessary shifting to the service mode.

The service button 2804 is in electrical communication with the controller 146 (FIG. 2). Upon shifting to the service mode, the controller 146 may operate at least one or both of the lifting assembly 124 and the latch 132 to permit the pressure in the storage chamber 120 to return the piston 112 to BDC (or any refill location of the piston 112 between BDC and TDC). Other operations, for example, electrical decoupling of the battery or deactivation of the motor 128, may occur once the service mode is entered.

FIG. 42 illustrates a second mode switching system 2800b including a handle door sensor 2808 to monitor presence of the door 350 and to shift the powered fastener driver 100 into the service mode upon detection that the door 350 is in an opened position. The handle door sensor 2808 may be mounted on a printed circuit board within the handle portion 152a of the housing 152. The door 350 must be removed to access the fill port 300 for connection of a fill adapter assembly 700 (or fill adapter assembly 2600) to the fill port 300. The handle door sensor 2808 is in electrical communication with the controller 146 and may function as described above with regard to the user-actuatable service button 2804 to shift the fastener driver 100 into and out of the service mode depending on the position or presence of the door 350.

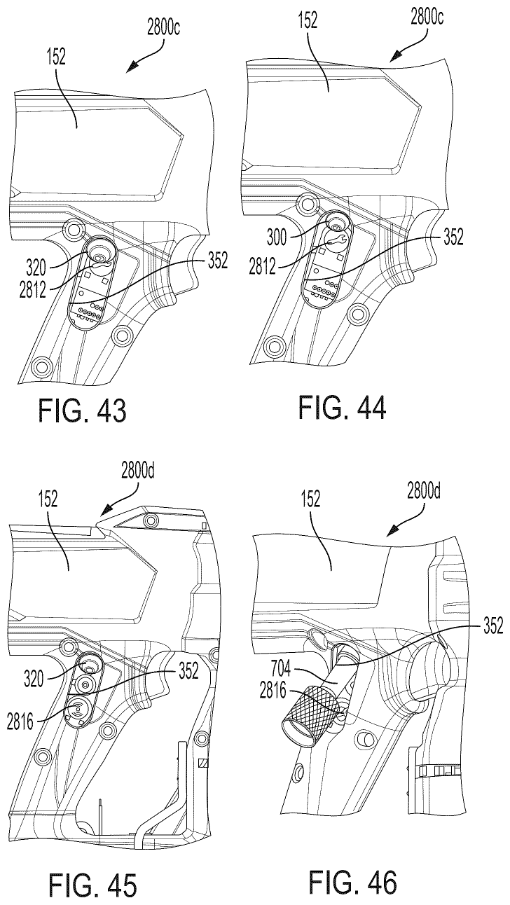

FIGS. 43 and 44 illustrate a third mode switching system 2800c including a plug sensor 2812 configured to monitor whether the plug 320 is present on the fill port 300 and to shift the fastener driver 100 into the service mode upon detection that the plug is not present on (e.g., disconnected from, decoupled form) the fill port 300. The plug 320 must be removed to access the fill port 300. FIG. 43 illustrates the plug 320 covering the fill port 300, whereas FIG. 44 illustrates the fill port 300 with the plug 320 removed, at which point the fastener driver 100 is shifted into the service mode.

FIGS. 45 and 46 illustrate a fourth mode switching system 2800d including a fill adapter sensor 2816 configured to monitor whether a fill adapter assembly 700 (and more specifically, the adapter 704) is engaged with the fill port 300 and to shift the fastener driver 100 into the service mode upon detection that the adapter 704 is engaged with the fill port 300. As shown in FIG. 45, the plug 320 is first removed, and then the adapter 704 is engaged with the fill port 300. The fill adapter sensor 2816 detects the proximity or presence of the adapter 704, and transmits an electrical signal to the controller 146 to enter service mode.

Various types of sensors may be used for the handle door sensor 2808, plug sensor 2812, and fill adapter sensor 2816. For example and without limitation, the handle door sensor 2808 may be a mechanical switch, a Hall-effect sensor, an inductive sensor, a Radio Frequency Identification (RFID) chip, an optical sensor, or the like. Operating curves of the handle door sensor 2808, plug sensor 2812, and fill adapter sensor 2816 may be optimized to correspond with position ranges of their corresponding sensor target object (e.g., the door 350, plug 320, and adapter 704). The illustrated embodiments include only one of the mode switching systems 2800. However, in other embodiments, multiple (different) mode switching systems 2800 may be present on the same fastener driver 100, with data therefrom optionally being compiled and cross-referenced by the controller 146.

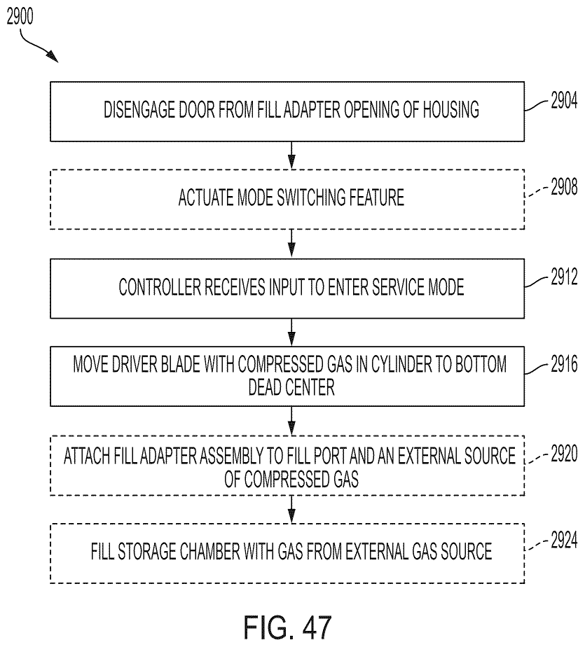

FIG. 47 illustrates a method 2900 for shifting the fastener driver 100 into a service mode and optionally refilling the storage chamber 120 of the fastener driver 100 utilizing at least one of the first four mode switching systems 2800. At step 2904, the door 350 is disengaged from the fill adapter opening 352 of the housing 152. At step 2908, a mode-switching system 2800 is actuated. Step 2908 may be completed, for example, by the user-actuatable service button 2804 being actuated by a user; the handle door sensor 2808 detecting that the door 350 is moved or not present; the plug sensor 2812 detecting that that plug 320 is moved or not present; and/or the fill adapter sensor 2816 detecting that the adapter 704 is present and/or engaged with the fill port 300. At step 2912, the controller 146 receives an input signal from the mode-switching system 2800 to enter a service mode. At step 2916, the service mode is entered, for example, by moving the driver blade 116 to the BDC position using the compressed gas in the storage chamber 120. At step 2920, a fill adapter assembly 700, 2300, 2600 is attached to the fill port fill port 300 and to an external source of compressed gas ES. At step 2924, the storage chamber 120 is filled with gas from the external gas source ES, for example, in accordance with the filling method 2700.

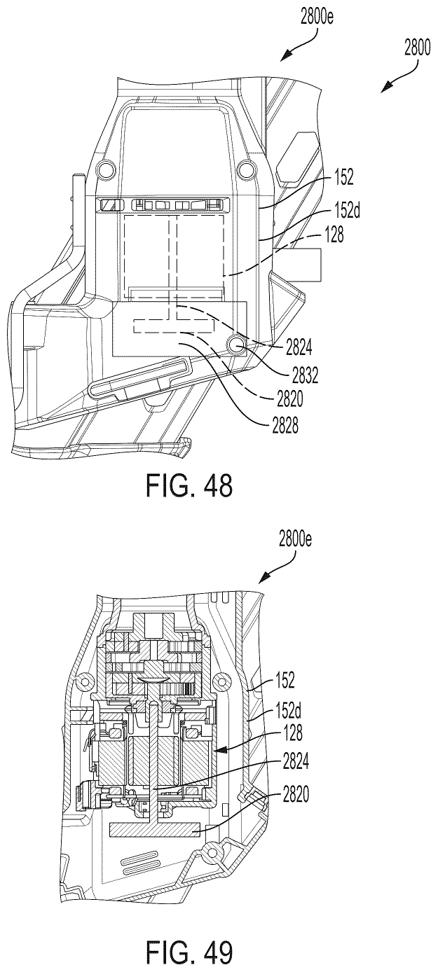

FIGS. 48 and 49 illustrate a fifth mode switching system 2800e including a handle portion 2820 coupled to and movable with a rotor shaft 2824 of the motor 128. The motor housing portion 152d may include a removable cover 2828 and a fastener 2832 securing the cover 2828 to the motor housing portion 152d. With the cover 2828 removed, a refill operator may reach into the motor housing portion 152d to manually rotate the rotor shaft 2824 and thereby cause movement of the lifting assembly 124 (e.g., the lifter teeth 124a) relative to the driver blade 116 (the driver blade teeth 116a) to permit the compressed gas in the storage chamber 120 to push the piston 112 to BDC (or any other service mode position, for example, between TDC and BDC). The handle portion 2820 may be coupled with the rotor shaft 2824 during normal use. In some embodiments, the handle portion 2820 may be integrally formed with the rotor shaft 2824. In other embodiments, the handle portion 2820 may be attached to the rotor shaft 2824 only when the cover 2828 is moved or removed (e.g., during shifting to the service mode or other actuation of the rotor shaft 2824). The handle portion 2820 may be user-actuated or optionally engaged by a different power tool to rotate the rotor shaft 2824.

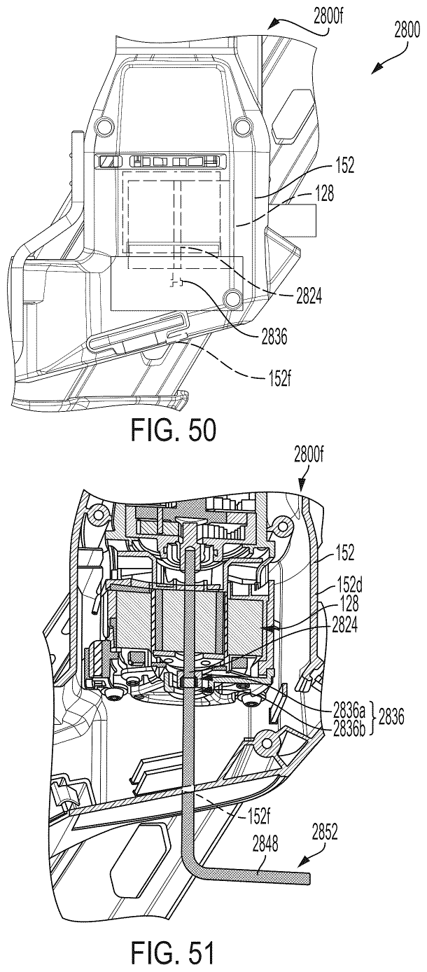

FIGS. 50 and 51 illustrate a sixth mode switching system 2800f including a coupling 2836. The coupling 2836 includes a first coupling member 2836a at an end of the rotor shaft 2824 (e.g., a female hexagonal receptacle), and a second coupling member 2836b formed by an end of a tool 2848 (e.g., an Allen key or other hexagonal tool, Torx bit, or other tool, a male hexagonal shaft). The coupling 2836 is engaged when the tool 2848 is passed through an access port 152f of the housing 152. The illustrated access port 152f is positioned at the rear of the housing 152 and is generally aligned with the longitudinal orientation of the rotor shaft 2824, although other arrangements for the access port 152f are possible. A second end 2852 of the tool 2848 is accessible from outside the housing 152 with the first coupling member 2836a and the second coupling member 2836b engaged with one another. The illustrated second end 2852 is angled (e.g., at 90 degrees) relative to the second coupling member 2836b. However, in other embodiments, the second end 2852 need not be angled relative to the second coupling member 2836b. The second end 2852 may be user-actuated or optionally engaged by a different power tool to rotate the rotor shaft 2824.

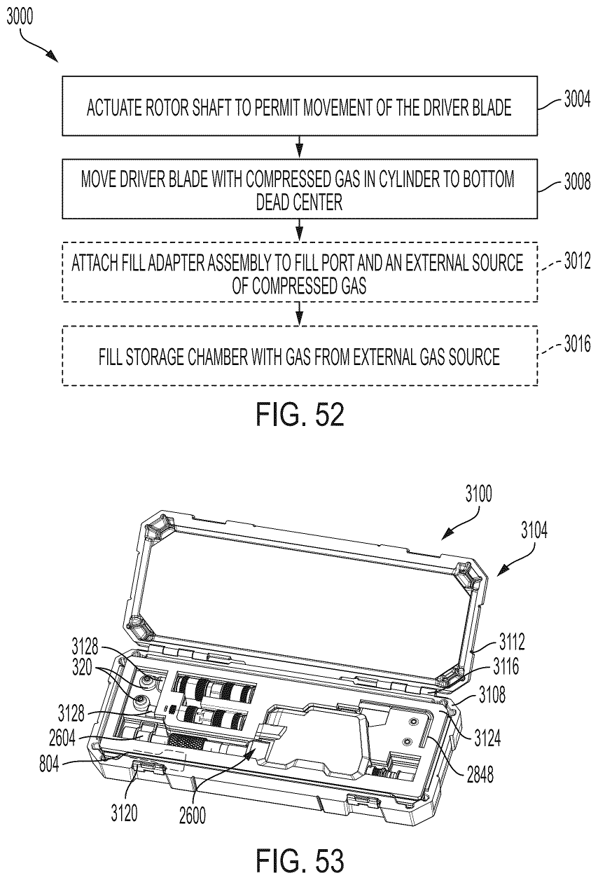

FIG. 52 illustrates a method 3000 for shifting the fastener driver 100 into a service mode and optionally refilling the storage chamber 120 of the fastener driver 100 utilizing the fifth or sixth mode switching systems 2800. Generally speaking, the fifth and sixth mode switching systems 2800 involve mechanical movement of the rotor shaft 2824 to cause the shift to the service mode. At step 3004, the rotor shaft 2824 is actuated to permit movement of the driver blade 116. At step 3008, the driver blade driver blade 116 is moved with compressed gas in the storage chamber 120 to a BDC position (or any other position corresponding with the service mode, e.g., any position between BDC and TDC). At step 3012, a fill adapter assembly 700, 2300, 2600 is attached to the fill port 300 and to an external source of compressed gas FS. At step 3016, the plug 320 is filled with gas from the external source of compressed gas FS, for example, in accordance with the filling method 2700.

FIG. 53 illustrates a fill adapter kit 3100 including a case 3104 and at least one fill adapter assembly 700, 2300, 2600 (which is illustrated). The case 3104 includes a base 3108 and a lid 3112 coupled to one another by a hinge 3116 and to be held in a closed position by a closure 3120. The case 3104 further includes padding 3124 with depressions to receive the fill adapter assembly 2600 including the tool adapter 2604, tool 2848, plugs 320, 620, and at least one other fitting 3128. The padding 3124 and case 3104 may shield the components within the case 3104 from damage due to impact of the case 3104 (e.g., from drops or other impacts). The padding 3124 may be made of, for example, a high density foam such as and without limitation, polyethylene foam, polyurethane foam, plastazote foam, rebond foam, and the like) or other material. The fitting 3128 may be a quick-release fitting or other coupling to facilitate connection of the fill adapter manifold 2616 to other fittings not provided by either the tool adapter 2604 or the hose adapter 2612. For example, the case 3104 may store one or more of the adapters 804 (illustrated), 904, 1004 associated and dimensioned to correspond with certain groups 458, 462, 466, 470, 474 of the powered fastener driver system 400. The case 3104 may be carried between worksites to provide access to the fill adapter assembly 2600 and accessories in the same place for conducting maintenance on any of the plurality of fastener drivers 100, 404, 408, 412, 416, 420, 424, 428, 432, 436, 440, 444, 448, 452. The fill adapter kit 3100 may be sold individually or as part of a system including one fastener driver 100 or at least two fastener drivers 100, 408 of different groups 458, 462.

Although the invention has been described in detail with reference to certain preferred embodiments, variations and modifications exist within the scope and spirit of one or more independent aspects of the invention as described.

Various features of the invention are set forth in the following claims.

1.-34. (canceled)

35. A powered fastener driver comprising:
a cylinder in which a compressed gas is maintained;
a piston movable within the cylinder from a top-dead-center (TDC) position to a bottom-dead-center (BDC) position by the compressed gas;
a driver blade coupled for movement with the piston from the TDC position to the BDC position for driving a fastener into a workpiece;
a fill port in fluid communication with the cylinder through which compressed gas is transferred into the cylinder;
a housing within which the fill port and cylinder are positioned, the housing including a fill adapter opening adjacent the fill port;
a door selectively engageable with the housing at the fill adapter opening between a first position covering the fill adapter opening and a second position uncovering the fill port; and
a mode switching system configured to switch an operating mode of the powered fastener driver, the mode switching system at least partially positioned within the housing and covered by the door when the door is in the first position,
wherein the mode switching system is configured to shift the powered fastener driver to a service mode when the door is in the second position.

36. The powered fastener driver of claim 35, wherein the mode switching system includes a user-actuatable service button, and wherein the powered fastener driver is shifted into the service mode in response to actuation of the service button.

37. The powered fastener driver of claim 36, wherein the user-actuatable service button is mounted on a printed circuit board.

38. The powered fastener driver of claim 36, wherein the user-actuatable service button is positioned within a handle portion of the housing.

39. The powered fastener driver of claim 35, wherein the mode switching system includes a handle door sensor configured to monitor presence of the door, and wherein the powered fastener driver is shifted into the service mode in response to detection that the door is in an open position.

40. The powered fastener driver of claim 39, wherein the handle door sensor includes at least one of a mechanical switch, a Hall-effect sensor, an inductive sensor, a radio frequency identification chip, or an optical sensor.

41. The powered fastener driver of claim 35, wherein the mode switching system includes a plug sensor configured to detect a plug attached to the fill port, and wherein the powered fastener driver is shifted into the service mode in response to detection that the plug is removed from the fill port.

42. The powered fastener driver of claim 35, wherein the mode switching system includes a fill adapter sensor configured to detect a fill adapter attached to the fill port, and wherein the powered fastener driver is shifted into the service mode in response to detection that the fill adapter is attached to the fill port.

43. The powered fastener driver of claim 35, further comprising a controller in electrical communication with the mode switching system, the controller and the mode switching system together facilitating the shift of the powered fastener driver to the service mode.

44. A powered fastener driver and fill adapter system, the system comprising:
a powered fastener driver including
a cylinder in which a compressed gas is maintained,
a piston movable within the cylinder from a top-dead-center (TDC) position to a bottom-dead-center (BDC) position by the compressed gas,
a driver blade coupled for movement with the piston from the TDC position to the BDC position for driving a fastener into a workpiece, and
a fill port in fluid communication with the cylinder through which compressed gas is transferred into the cylinder; and
a fill adapter including
a manifold,
a first coupling engaged with the manifold and configured to be engaged with an external supply of compressed gas,
a second coupling engaged with the manifold and configured to be engaged with the fill port of the powered fastener driver,
a pressure gauge in fluid communication with the manifold and configured to indicate a pressure of the compressed gas in the cylinder, and
a release valve in fluid communication with the manifold, the release valve movable between an open position in which the manifold is in fluid communication with an environment of the fill adapter and a closed position.

45. The system of claim 44, wherein the fill adapter further comprises a housing surrounding at least a portion of the manifold and the release valve, and wherein the housing includes a vent hole through which compressed gas discharged from the release valve and into the housing can be exhausted.

46. The system of claim 44, wherein the fill adapter further comprises a button, and wherein the release valve is a slow bleeder valve configured to be opened in response to a user depressing the button.

47. The system of claim 46, wherein the slow bleeder valve includes a relief hole having an area of less than 1 square millimeter.

48. The system of claim 47, wherein the slow bleeder valve includes a relief hole having an area of less than 0.1 square millimeters.

49. The system of claim 44, wherein the release valve is movable to the open position when a pressure of the cylinder exceeds a threshold pressure above a target pressure of the cylinder.

50. The system of claim 44, wherein the release valve is a first release valve, wherein the fill adapter further includes a second release valve in fluid communication with the manifold, and wherein the second release valve is movable between a closed position and an open position in which the manifold is in fluid communication with an environment of the fill adapter through the second release valve.

51. The system of claim 50, wherein the first release valve includes a first relief hole having a first area and the second release valve includes a second release hole having a second area greater than the first area.

52. The system of claim 51, wherein the fill adapter further comprises:
a housing surrounding at least a portion of the manifold and the release valve,
a button protruding from a top wall of the housing for actuating the release valve,
a quick-release fitting extending from a back wall of the housing, the quick-release fitting configured to be fluidly connected to an external source of compressed gas, and
a tool adapter extending from a front wall of the housing to which the fill port is attachable.

53. The system of claim 52, wherein the top wall of the housing includes a hole through which the pressure gauge is visible.

54. The system of claim 44, wherein the powered fastener driver includes a mode switching system configured to switch an operating mode of the powered fastener driver, the mode switching system at least partially positioned within the housing and covered by a door attached to a fill adapter opening of the housing adjacent the fill port, and
wherein the mode switching system is configured to shift the powered fastener driver to a service mode when the door is in the second position.
